(19) United States
(12) Patent Application Publication
(10) Pub. No.: US 2023/0316555 A1
(43) Pub. Date: Oct. 5, 2023

(54) System and Method for Image-Based Remote Sensing of Crop Plants

(71) Applicant: Agriculture Victoria Services Pty Ltd, Bundoora (AU)

(72) Inventors: German Carlos Spangenberg, Bundoora (AU); Bikram Pratap Banerjee, Bundoora (AU); Surya Kant, Bundoora (AU)

(21) Appl. No.: 18/020,168

(22) PCT Filed: Aug. 6, 2021
(86) PCT No.: PCT/AU2021/050859

§ 371 Date: Feb. 7, 2023

(30) Foreign Application Priority Data
Aug. 14, 2020 (AU) 2020902903

(51) Int. Cl. G06T 7/62; G06T 3/40; G06T 17/05; G06T 7/33

(52) U.S. Cl. CPC G06T 7/62; G06T 3/4038; G06T 17/05; G06T 7/344; G06T 7/337; G06T 2207/30188; G06T 2207/10036; G06T 2207/20221

(57) ABSTRACT

Methods for image-based remote sensing of crop plants include: acquiring images of the crop plants from a camera flown over the crop by an unmanned/uncrewed aerial vehicle (UAV); forming an artificial neural network (ANN); and using the trained ANN to identify and/or measure one or more phenotypic characteristics of the crop plants in the images by classification and/or regression; and/or obtaining multispectral images of the crop plants from a multispectral camera flown over the crop by the UAV; mosaicking the multispectral images together; determining crop measurement metrics; crop height model (CHM), crop coverage (CC) and crop volume (CV) representing the crop plants in three dimensions from a fusion of a digital surface model and a digital terrain model; determining various vegetation indices (VIs) based on the multispectral orthomosaic reflectance map; and determining a measurement of dry biomass using CV and fresh biomass using CV×VIs.

### TECHNICAL FIELD

The present disclosure relates to a system and a method for image-based remote sensing of crop plants.

### BACKGROUND

Efficient, precise and timely measurement of crop plant traits is important in the assessment of a breeding population. Modern plant breeding strategies rely on efficient genotyping and phenotyping for improving yield, that is, by studying the phenotypic responses in diverse germplasm.

The traditional phenotyping method to measure crop plant traits such as above-ground biomass (AGB)—includes destructively harvesting samples of the crop to measure fresh weight (FW), and oven drying the harvested samples to measure dry weight (DW). Retrieving the AGB measures such as the DW and the FW has remained challenging under field conditions with a variety of genotypes having diverse growth response including during reproductive and senescence stages. Using the traditional method, to investigate the biomass of a diverse number of genotypes in field breeding research, a large number of plants needs to be harvested regularly over different growth stages, which is very time consuming and labour intensive. Moreover, as this method is destructive, it is impossible to take multiple measurements on the same plot at different time points. Although some image processing methods and systems have been proposed for remote sensing of crops, developing high-performance algorithms for certain tasks with existing tools remains time-consuming, resource expensive and relies heavily on human expertise and trial-and-error processes.

It is desired to address or ameliorate one or more disadvantages or limitations associated with the prior art, or to at least provide a useful alternative.

### SUMMARY

Disclosed herein is a method for image-based remote sensing of crop plants, the method including:
a. obtaining multispectral images of crop plants from a multispectral camera flown over the crop by an unmanned/uncrewed aerial vehicle (UAV);
b. mosaicking the multispectral images together using a structure-from-motion (SfM) method to produce:
   i. a multispectral orthomosaic reflectance map of the crop plants,
   ii. a digital surface model (DSM) of the crop plants, and a
   iii. a digital terrain model (DTM) of the crop plants;
c. determining a crop height model (CHM) representing the crop plants in three dimensions (3D) from a fusion of the DSM and the DTM;
d. determining an optimized soil adjusted vegetation index (OSAVI) based on the multispectral orthomosaic reflectance map; and
e. determining a measurement of biomass of the crop plants by comparing the CHM and the OSAVI, including:
   i. determining crop volume (CV) through a fusion of CHM and crop coverage (CC) to measure entire volume of the standing crop to model dry weight (DW) biomass, and/or
   ii. modelling fresh weight (FW) biomass through a fusion of CV and vegetation indices (VIs).

The SfM method can include using green bands of the multispectral images as a reference band.

The SfM method can include geometrically registering the orthomosaic reflectance map with the DSM and the DTM using one or more ground control points (GCPs) in the images adjacent to or in the crop.

The method can include determining the CC (optionally in the form of a CC layer) from a fusion of the OSAVI and the CHM. The fusion of the OSAVI (optionally in the form of an OSAVI layer) and the CHM (optionally in the form of a CHM layer) can include a pixel-wise product of the OSAVI layer and the CHM layer.

The CHM and the multispectral orthomosaic reflectance map are complementary and both represent the same crop area.

Disclosed herein is a system for image-based remote sensing of crop plants, the system including an aerial data acquisition system with:
a. an unmanned/uncrewed aerial vehicle (UAV); and
b. a multispectral camera mounted to the UAV for acquiring multispectral images of the crop plants,
   the system further including a computing system configured to perform a data-processing method including:
a. mosaicking the multispectral images together using a structure-from-motion (SfM) method to produce:
   i. a multispectral orthomosaic reflectance map of the crop plants,
   ii. a digital surface model (DSM) of the crop plants, and a
   iii. a digital terrain model (DTM) of the crop plants;
b. determining a crop height model (CHM) representing the crop plants in three dimensions (3D) from a fusion of the DSM and the DTM;
c. determining an optimized soil adjusted vegetation index (OSAVI) based on the multispectral orthomosaic reflectance map; and
d. determining a measurement of biomass of the crop plants by comparing the CHM and the OSAVI, including:
   i. determining crop volume (CV) through a fusion of CHM and crop coverage (CC) to measure entire volume of the standing crop to model dry weight (DW) biomass, and/or
   ii. modelling fresh weight (FW) biomass through a fusion of CV and vegetation indices (VIs).

Disclosed herein is machine-readable storage media including machine readable instructions that, when executed by a computing system, perform a data-processing method including:
a. mosaicking multispectral images of crop plants together using a structure-from-motion (SfM) method to produce:
   i. a multispectral orthomosaic reflectance map of the crop plants,
   ii. a digital surface model (DSM) of the crop plants, and a
   iii. a digital terrain model (DTM) of the crop plants;
b. determining a crop height model (CHM) representing the crop plants in three dimensions (3D) from a fusion of the DSM and the DTM;
c. determining an optimized soil adjusted vegetation index (OSAVI) based on the multispectral orthomosaic reflectance map; and
d. determining a measurement of biomass of the crop plants by comparing the CHM and the OSAVI, including:
   i. determining crop volume (CV) through a fusion of CHM and crop coverage (CC) to measure entire volume of the standing crop to model dry weight (DW) biomass, and/or
   ii. modelling fresh weight (FW) biomass through a fusion of CV and vegetation indices (VIs).

Disclosed herein is a method for image-based remote sensing of crop plants, the method including:
a. acquiring images of the crop plants from a camera flown over the crop by an unmanned/uncrewed aerial vehicle (UAV);
b. forming an artificial neural network (ANN) by:
   i. uploading the images to a neural architecture search (NAS) module to select a neural architecture for the artificial neural network (ANN), and
   ii. training the ANN using the images; and
c. using the trained ANN to identify and/or measure one or more phenotypic characteristics of the crop plants in the images by classification and/or regression.

The crop plants may include wheat. The phenotypic characteristics of the crop plants include whether or not there is wheat lodging (i.e., a classification task), and/or a level (i.e., measure) of the wheat lodging using a lodging estimator of levels in the images, i.e., a regression task.

The method may include generating an orthomosaic image of the acquired images with measured coordinates of one or more ground control points (GCPs) used for geo-rectification.

Disclosed herein is a system for image-based remote sensing of crop plants, the system including an aerial data acquisition system with:
a. an unmanned/uncrewed aerial vehicle (UAV); and
b. an optical camera mounted to the UAV to acquire images of the crop plants, the system further including a:
a. receiving the images;
b. forming an artificial neural network (ANN) by:
   i. uploading the images to a neural architecture search (NAS) module to select a neural architecture for the artificial neural network (ANN), and
   ii. training the ANN using the images; and
c. using the trained ANN to identify and/or measure one or more phenotypic characteristics of the crop plants in the images by classification and/or regression.

The aerial data acquisition system can include a geotagging module to geotag each image.

The system can include one or more ground control points (GCPs) for geometric correction of the geotagging module.

Disclosed herein is machine-readable storage media including machine readable instructions that, when executed by a computing system, perform a data-processing method including:
a. receiving images of crop plants from a camera flown over the crop by an unmanned/uncrewed aerial vehicle (UAV);
b. forming an artificial neural network (ANN) by:
   i. uploading the images to a neural architecture search (NAS) module to select a neural architecture for the artificial neural network (ANN), and
   ii. training the ANN using the images; and
c. using the trained ANN to identify and/or measure one or more phenotypic characteristics of the crop plants in the images by classification and/or regression.

Disclosed herein is a method including:
a. receiving images of crop plants from a camera flown over the crop by an unmanned/uncrewed aerial vehicle (UAV);
b. classifying and/or regressing the images to identify and/or measure one or more phenotypic characteristics of the crop plants in the images using a trained artificial neural network (ANN), wherein the trained ANN has been trained by:
   i. uploading a training data set including training images of the crop plants to a neural architecture search (NAS) module to select a neural architecture for the artificial neural network (ANN), and
   ii. training the ANN using the training images.

Disclosed herein is a system including computing system configured to perform a data-processing method including:
a. receiving images of crop plants from a camera flown over the crop by an unmanned/uncrewed aerial vehicle (UAV);
b. classifying and/or regressing the images to identify and/or measure one or more phenotypic characteristics of the crop plants in the images using a trained artificial neural network (ANN), wherein the trained ANN has been trained by:
   i. uploading a training data set including training images of the crop plants to a neural architecture search (NAS) module to select a neural architecture for the artificial neural network (ANN), and
   ii. training the ANN using the training images.

Disclosed herein is machine-readable storage media including machine readable instructions that, when executed by a computing system, perform a classification task, including:
a. receiving images of crop plants from a camera flown over the crop by an unmanned/uncrewed aerial vehicle (UAV);
b. classifying and/or regressing the images to identify and/or measure one or more phenotypic characteristics of the crop plants in the images using a trained artificial neural network (ANN), wherein the trained ANN has been trained by:
   i. uploading a training data set including training images of the crop plants to a neural architecture search (NAS) module to select a neural architecture for the artificial neural network (ANN), and
   ii. training the ANN using the training images.

### BRIEF DESCRIPTION OF THE DRAWINGS

Some embodiments of the present invention are hereinafter described, by way of example only, with reference to the accompanying drawings, in which:

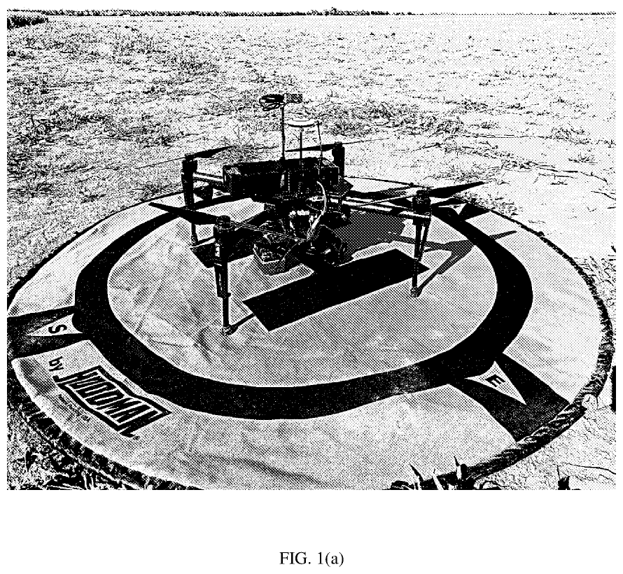

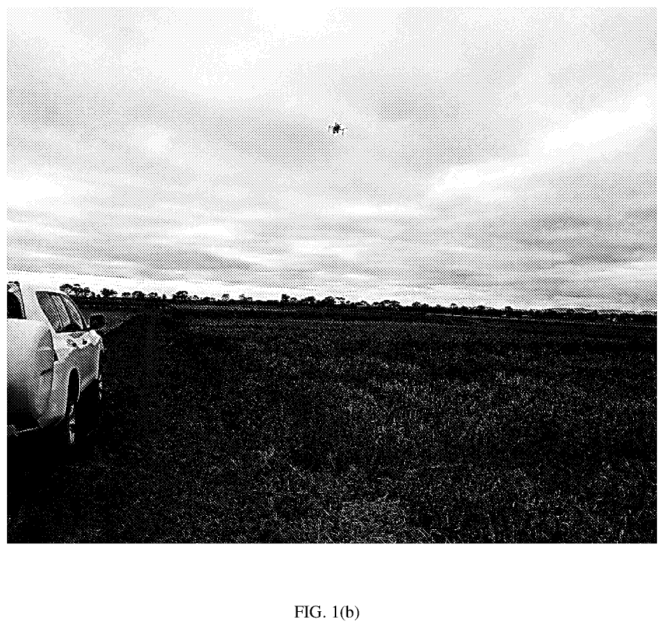

a. FIG. 1 are photographs of an example UAV, (a) at rest, and (b) in flight;

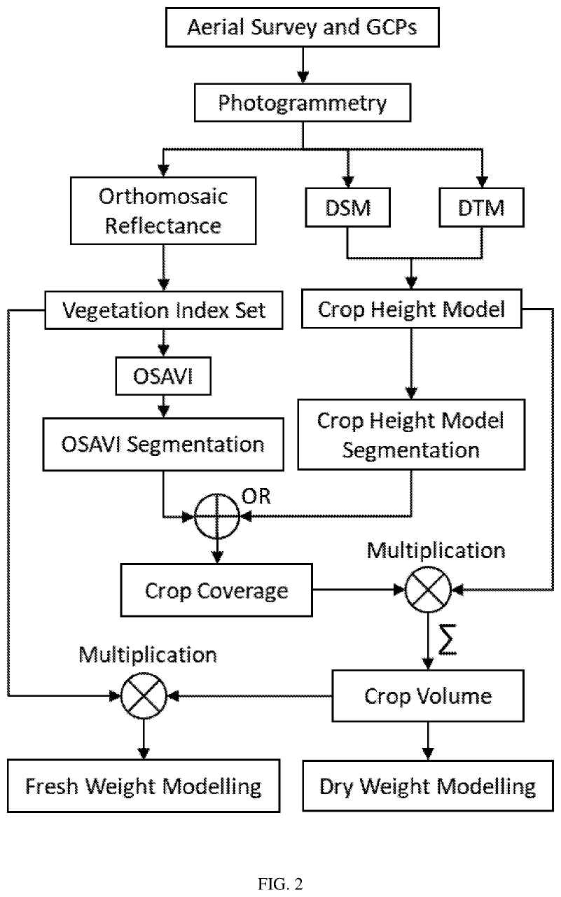

b. FIG. 2 is a flowchart of a fusion-based data-processing method described herein;

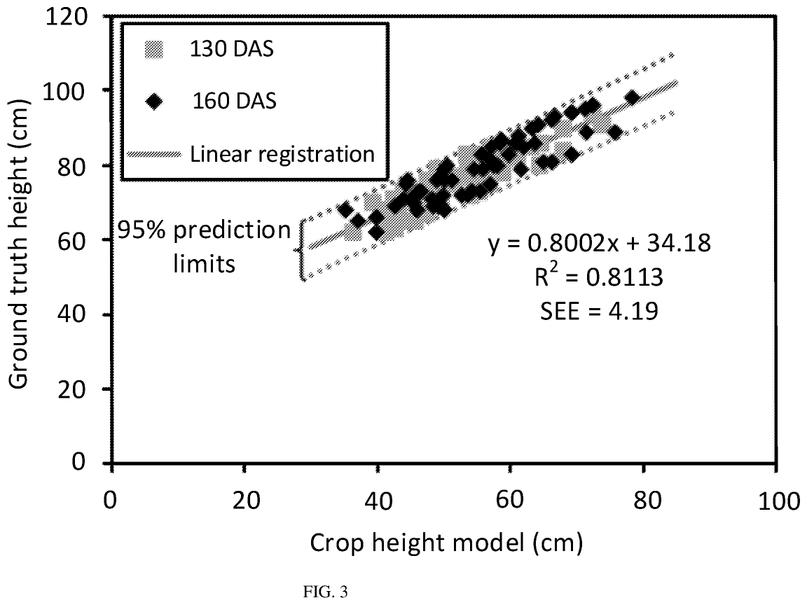

c. FIG. 3 is a graph of a correlation between computed crop height model (CHM) and observed ground truth (GT) height measurements at time points;

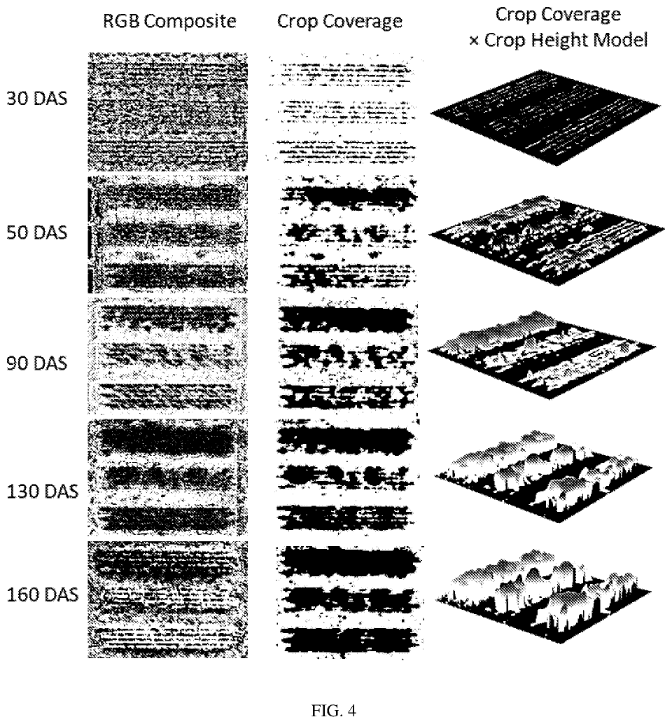

d. FIG. 4 is a set of images providing a visual evaluation of the performance of the data-processing method for computing crop coverage (CC) and CC×CHM at different growth stages on three wheat varieties with variable growth rates;

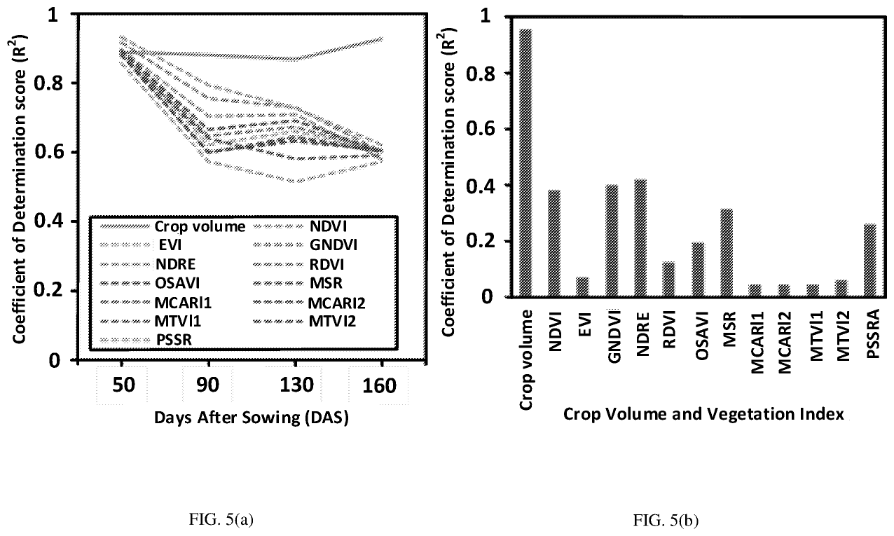

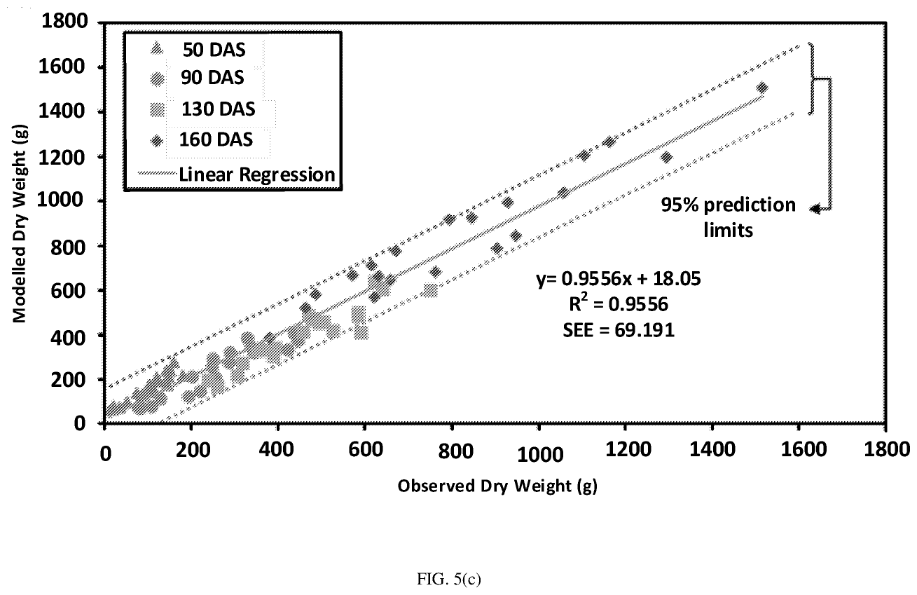

e. FIG. 5 is a set of graphs showing high-throughput estimation of dry biomass or dry weight (DW), including variability in the correlation of determination (R²) for modelling performed using crop volume (CV) and standard vegetation indices (VIs) (a) across different time points and (b) at all the time points combined against observed DW; and in (c) modelling results for DW derived from CV against observed DW readings;

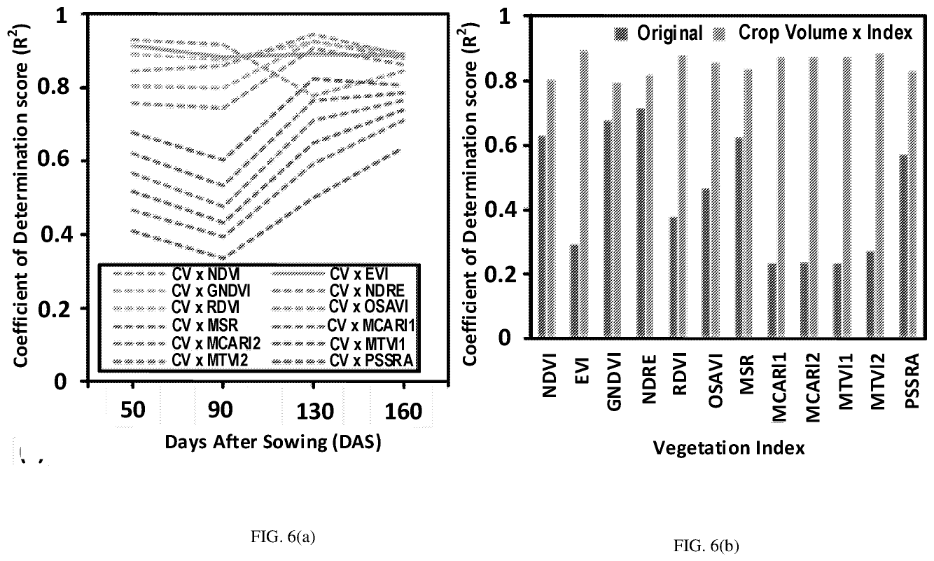

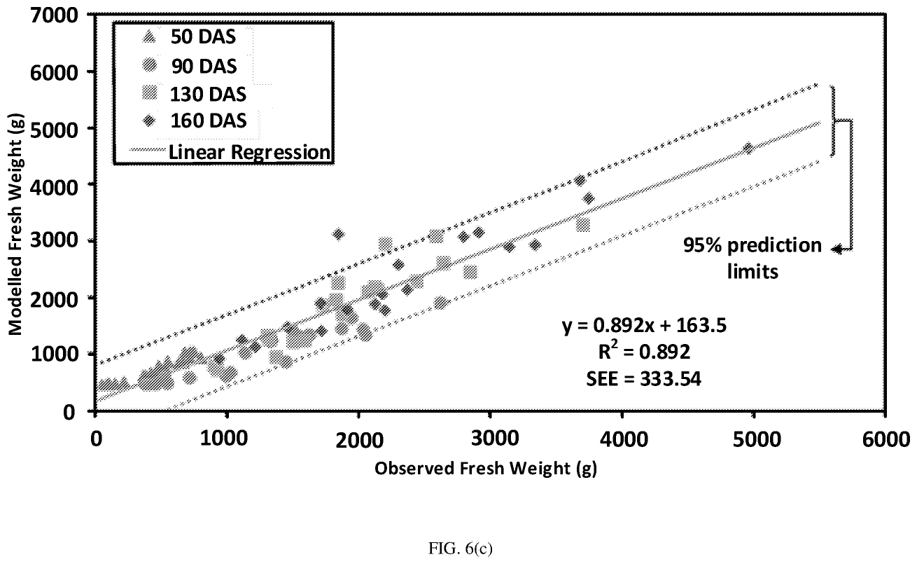

f. FIG. 6 is a set of graphs showing high-throughput estimation of fresh biomass or fresh weight (FW), including variability in the correlation of determination (R²) of crop volume multiplied using standard vegetation indices (CV×VIs) (a) across different time points and (b) at all the time points combined against observed FW; and in (c) modelling results for FW derived from CV×EVI against observed FW readings;

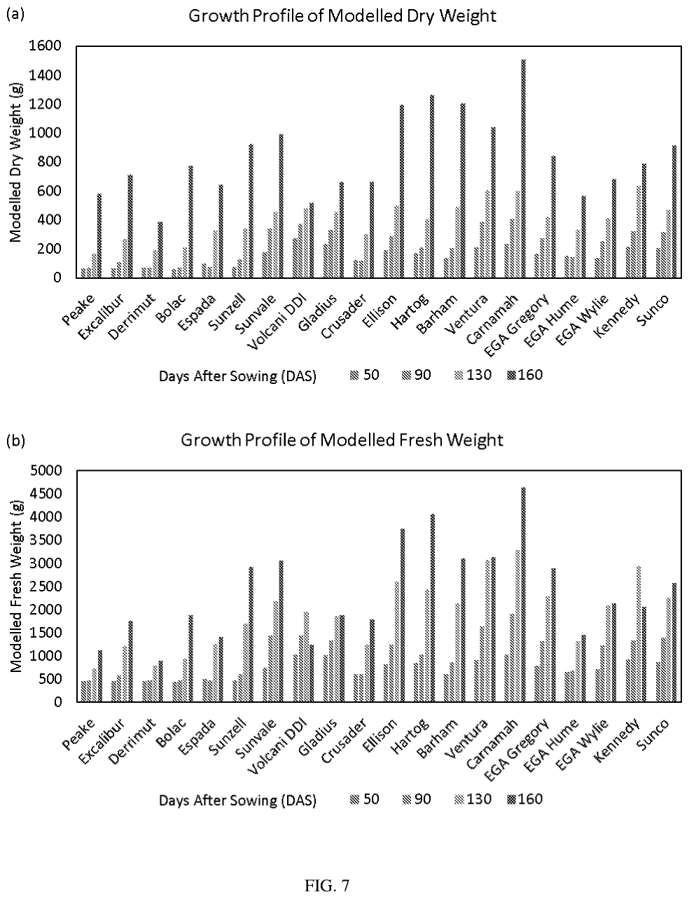

g. FIG. 7 is set of graphs showing a growth profile of modelled (a) Dry weight (DW) and (b) Fresh Weight (FW) at different time points;

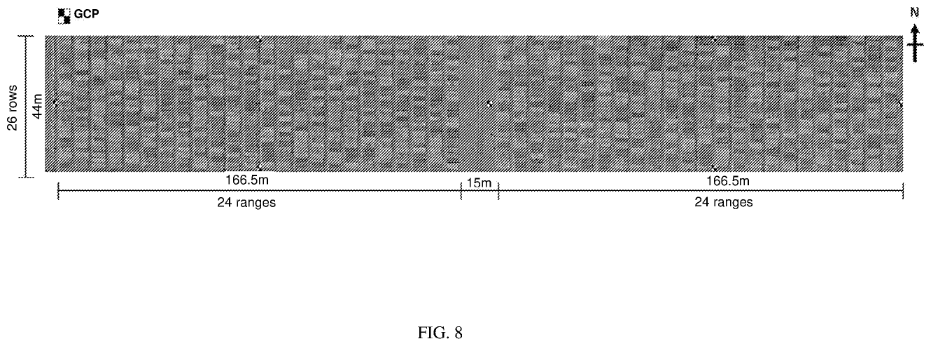

h. FIG. 8 is an image of an example wheat breeding field experiment with ground control points (GCPs) indicated using 2 by 2 black and white grids;

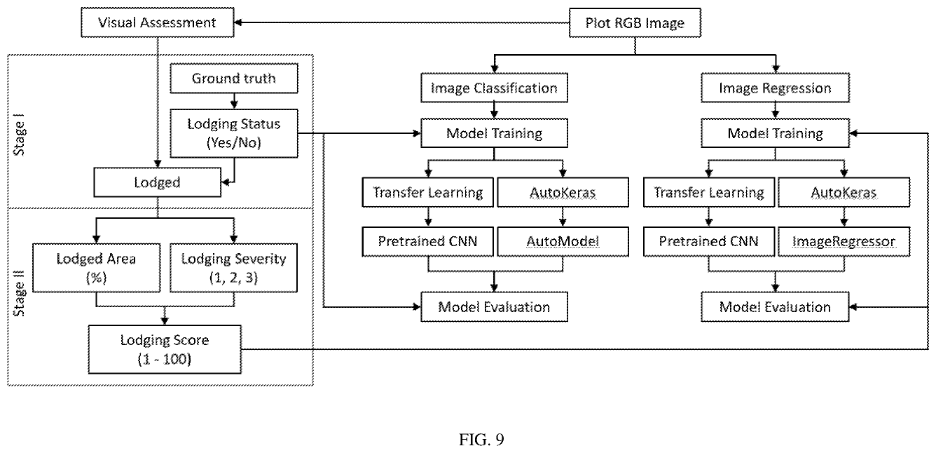

i. FIG. 9 is a flowchart of steps in a neural network method described herein;

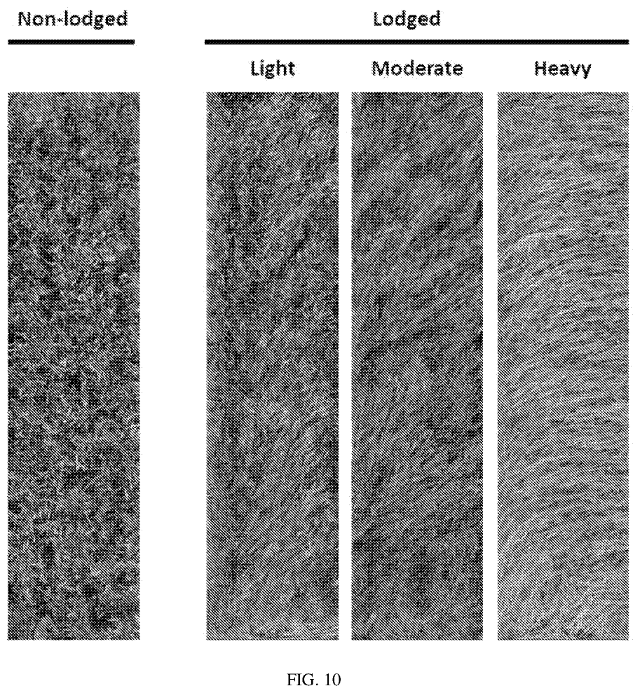

j. FIG. 10 is a set of images of mutually different exemplary wheat lodging severities in which wheat plot images were first classified as non-lodged or lodged using ground truth data, then plot images identified as lodged were assessed visually and divided into three lodging severities (light, moderate and heavy) based on lodging angles;

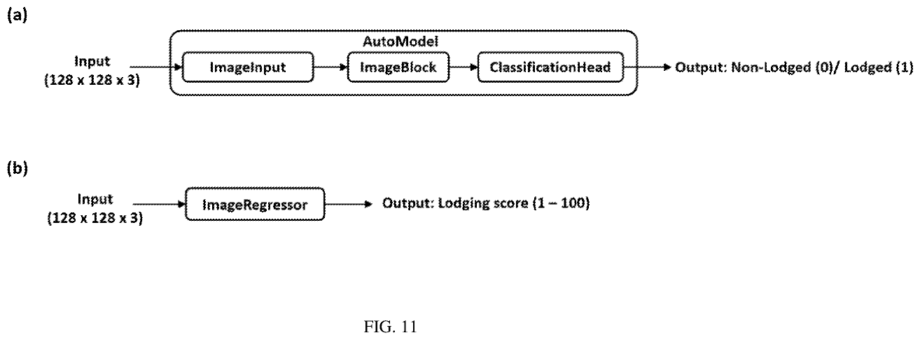

k. FIG. 11(a) is an example AutoModel for image classification, and 11(b) is an example ImageRegressor for image regression;

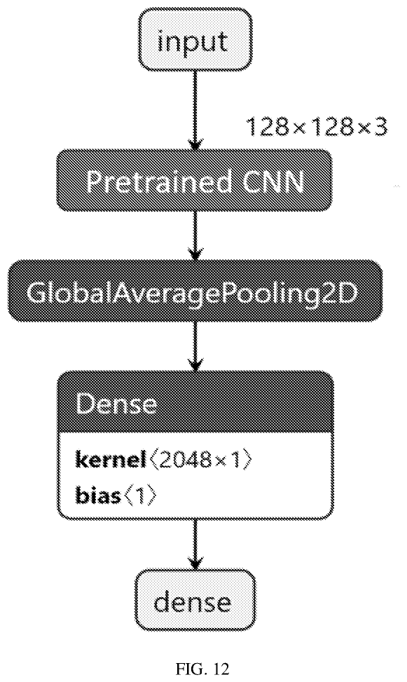

l. FIG. 12 is a diagram of a comparison ANN implemented using transfer learning with the ResNet-50 architecture, in which outputs from the ResNet-50 were joined to a global average pooling 2D layer and connected to a final dense layer, with the activation function set as either “sigmoid” for image classification or “linear” for image regression;

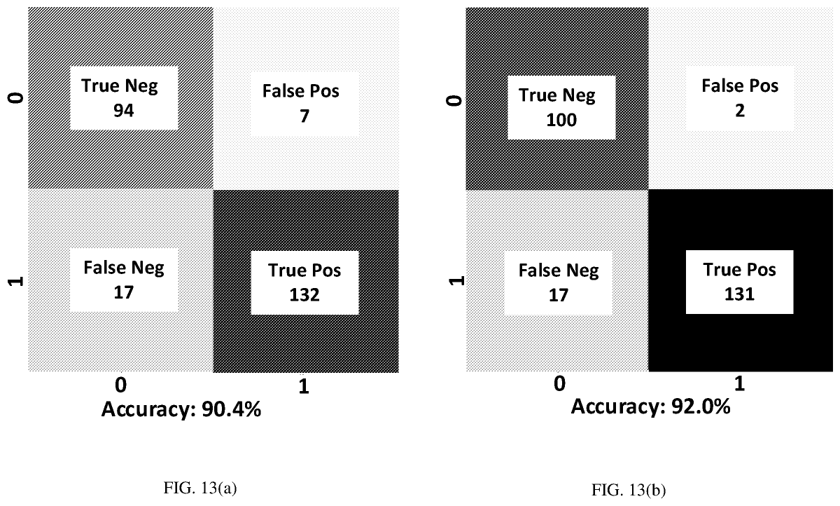

m. FIG. 13 is an example confusion matrix of the classification results using (a) the comparator ResNet-50 and (b) the NN model after 100 trials;

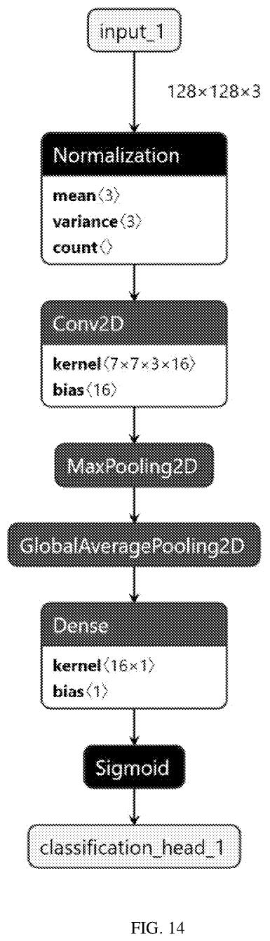

n. FIG. 14 is a model architecture diagram of an experimental example best in test ANN architecture for image classification in the form of a simple 2-layers CNN mo

o. del with 43,895 parameters after 50 and 100 trials;

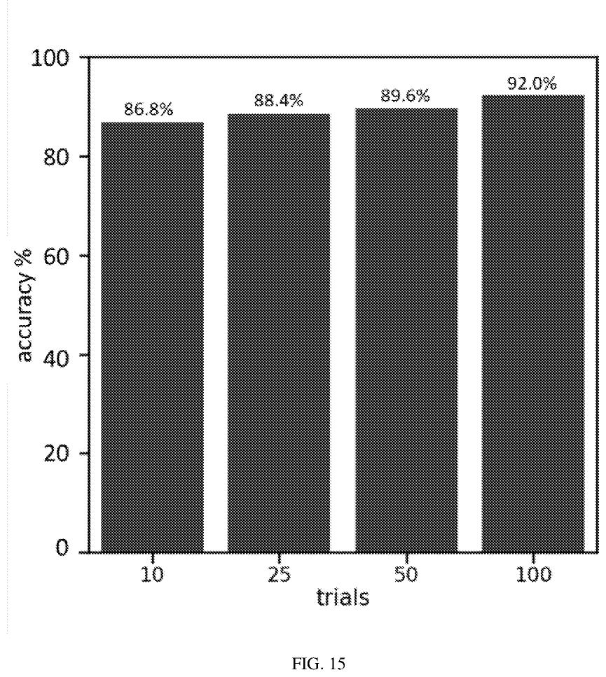

p. FIG. 15 is a bar graph of classification accuracy versus the number of trials for the NN model (10, 25, 50 and 100 trials);

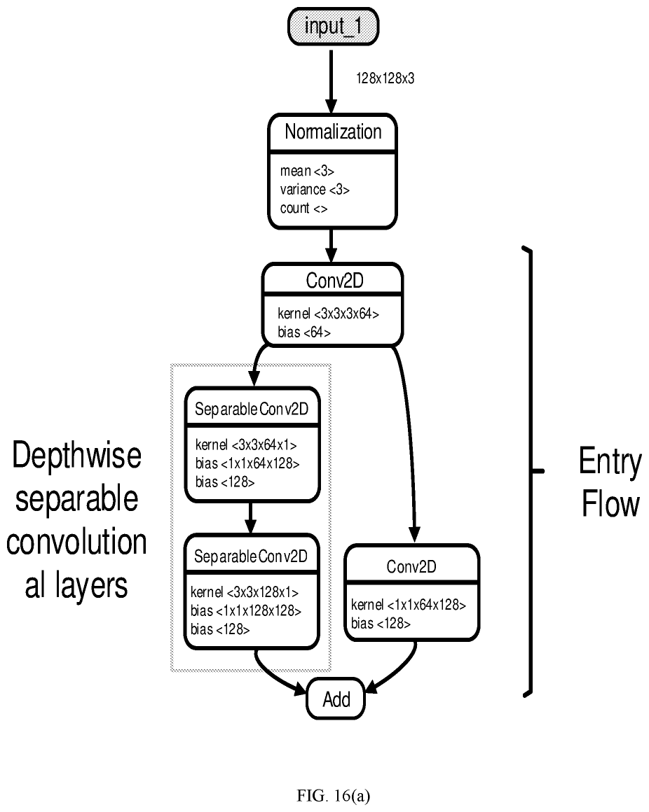

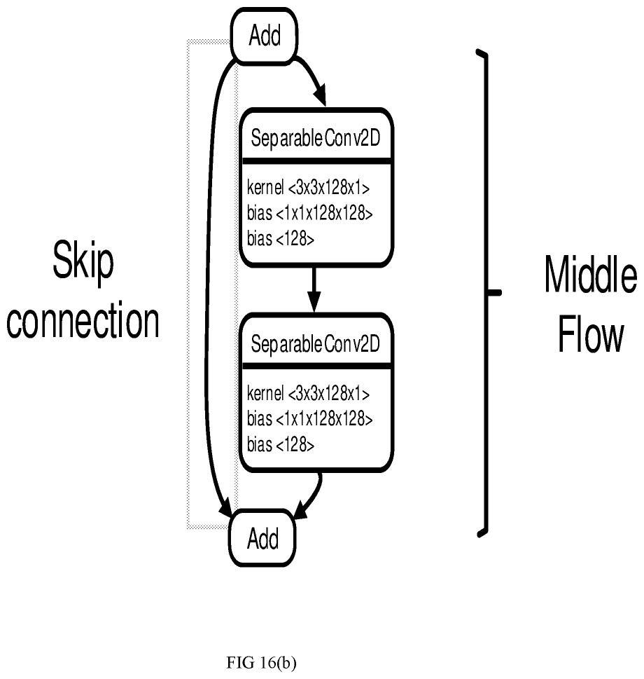

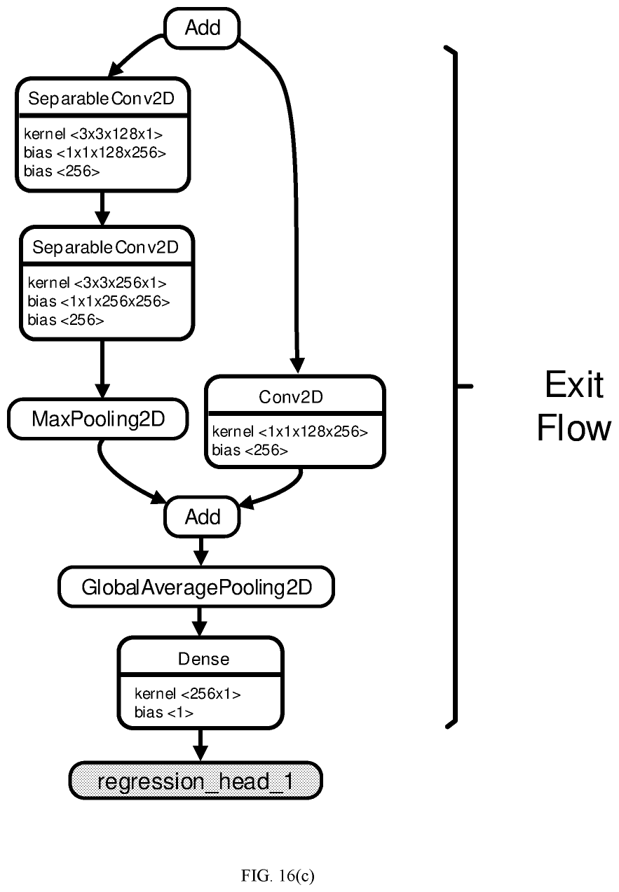

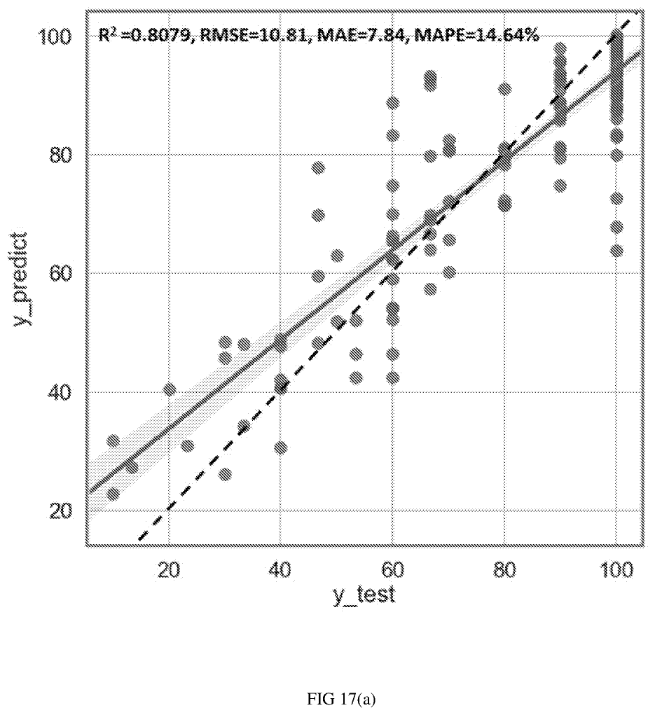

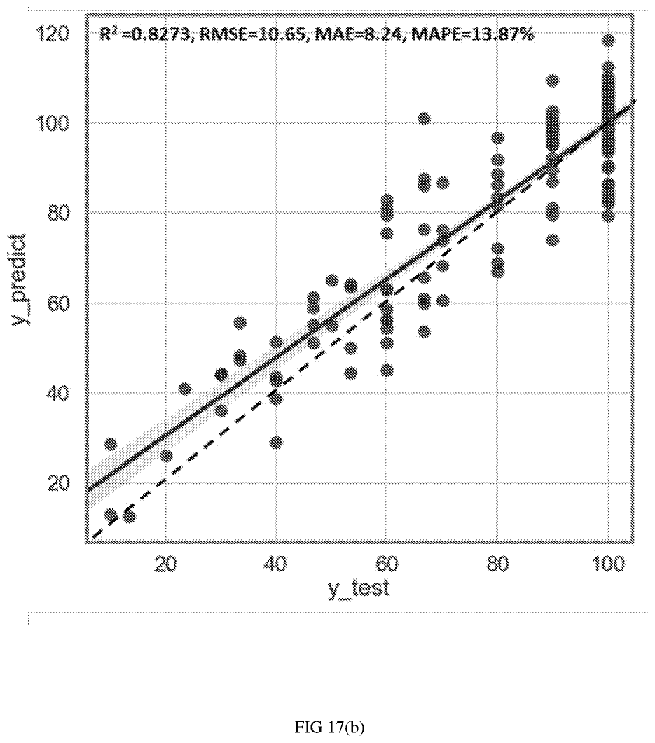

q. FIG. 16 is a model architecture diagram of an experimental example best in test ANN architecture for image regression: an 8-layers mini Xception model with 207,560 parameters was the best tested architecture discovered in 50 and 100 trials, wherein the model included three main parts (“entry flow”, “middle flow” and “exit flow”) and two key features (“MaxPooling2D” and “GlobalAveragePooling2D”) namely the depthwise separable convolutional layers and skip connections from the original Xception network may be discerned; and
r. FIG. 17 is a set of graphs of regression plots formed by plotting predicted lodging scores (y_predict) against actual scores (y_test), and including a regression line with a 95% confidence interval and dashed black line indicating the 1:1 line, for predicted outputs using (a) ResNet-50 and (b) the NN model.

### DETAILED DESCRIPTION

### Overview of Fusion Method

Disclosed herein is a method for image-based remote sensing of crop plants. Also disclosed herein is a system configured to perform the method.

The method (also referred to herein as the ‘fusion method’) includes:
a. obtaining multispectral images of crop plants (forming an above-ground crop) from a multispectral camera flown over the crop by an unmanned/uncrewed aerial vehicle (UAV);
b. mosaicking the multispectral images together using a structure-from-motion (SfM) method to produce:
   i. a multispectral orthomosaic reflectance map of the crop plants,
   ii. a digital surface model (DSM) of the crop plants, and a
   iii. a digital terrain model (DTM) of the crop plants;
c. determining a crop height model (CHM) representing the crop plants in three dimensions (3D) from a fusion of the DSM and the DTM;
d. determining an optimized soil adjusted vegetation index (OSAVI) based on the multispectral orthomosaic reflectance map; and
e. determining a measurement of biomass of the crop plants by comparing the CHM and the OSAVI, including:
   i. determining crop volume (CV) through a fusion of CHM and crop coverage (CC) to measure entire volume of the standing crop to model dry weight (DW) biomass, and/or
   ii. modelling fresh weight (FW) biomass through a fusion of CV and vegetation indices (VIs).

The three fusion steps may provide substantially improved accuracy. The DSM is a spectral representation of the crop, and the DTM is structural representation of the crop, so the DSM may be referred to as a “spectral layer”, and the DTM may be referred to as a “structural layer”. The method thus combines the spectral layer and the structural layer in one of the fusion steps.

The SfM method can include using green bands of the multispectral images as a reference band.

The method can include determining the CC (in the form of a CC layer) from a fusion of the OSAVI and the CHM. The fusion of the OSAVI (in the form of an OSAVI layer) and the CHM (in the form of a CHM layer) can include a pixel-wise product of the OSAVI layer and the CHM layer.

The co-called intermediate traits, including crop height model (CHM), crop coverage (CC) and crop volume (CV), may be capable of inferring important agronomic insights in high-throughput breeding research for screening genotypes or identifying genotypic markers governing the fundamental response of the genotypes. The method can include determining a measurement of crop yield based on: the crop coverage (CC) values; the crop volume (CV) values; and/or the biomass or above-ground biomass (AGB) values, which can be represented by a measure of a total dry weight (DW) or a total fresh weight (FW) of organic matter per unit area at a given time. Above-ground crop biomass is an important factor in the study of plant functional biology and growth, it is the basis of vigour and net primary productivity, and may be crucial for monitoring grain yield.

The CHM and the multispectral orthomosaic reflectance map are complementary and because they both represent the same crop area.

The DTM may be referred to as the digital elevation model (DEM).

The system (also referred to herein as the ‘fusion system’) includes an aerial data acquisition system with:
a. a multispectral camera (also referred to as a “multispectral sensor”);
b. a downwelling light sensor (DLS);
c. the UAV with a gimbal mount and vibration dampeners; and
d. a global positioning system (GPS) module for recording locations of the respective multispectral images.

The UAV is a small UAV. The UAV may be an off-the-shelf small UAV in the form of a quadcopter, e.g., as shown in FIG. 1.

The data acquisition system includes a switching mode power supply to step down the output voltage of the UAV to power the multispectral sensor.

The data acquisition system includes a gravity-assisted gimbal bracket (3D printed) that fastens and attaches the multispectral sensor to the gimbal mount.

The data acquisition system records position values of the images, i.e., latitude, longitude and altitude, on multispectral sensor tags using the GPS module.

The multispectral sensor may be an off-the-shelf multispectral camera.

The multispectral sensor logs dynamic changes in incident irradiance levels using the DLS.

The multispectral sensor may have five spectral bands: blue (475 nm), green (560 nm), red (668 nm), red edge (717 nm), and near-infrared (840 nm).

The multispectral sensor measures at-sensor radiance, the radiant flux received by the sensor. The at-sensor radiance is a function of surface radiance (i.e., flux of radiation from the surface) and atmospheric disturbance between the surface and the sensor, which may be assumed to be negligible for UAV-based surveys.

The data acquisition system is configured to trigger the multispectral sensor to acquire the images at a selected height above the crop, e.g., 30 m to provide a ground sampling distance (GSD) of 2 cm. The data acquisition system is configured to trigger the multispectral sensor to acquire adjacent images based on location from the GPS module with a selected overlap between adjacent images, e.g., 85% forward and side overlap.

The system includes at least one radiometric calibration panel (also referred to as a “standardised reflectance panel”) with known radiometric coefficients for individual multispectral bands. The method includes the multispectral sensor recording radiometric calibration measurements from the radiometric calibration panel before individual flight missions. The method includes image correction of the acquired images using the radiometric calibration measurements.

The camera records at-sensor radiance measurements for each band in dynamically scaled digital numbers (DNs) at a predetermined bit depth, thus forming the raw images. The method includes using the at least one radiometric calibration panel to establish a linear empirical relationship between the DNs and surface reflectance during the survey by measuring the surface reflectance of the radiometric calibration panel under consistent illumination conditions during the survey. In the method, the logs from the onboard DLS are used to account for changes in irradiation during the acquisition of the images (by application of the linear empirical relationship to the raw DNs).

The method includes acquiring the mutually overlapping images of a field site (also referred to as a ‘study area’) that includes the crop plants.

The system includes one or more ground control points (GCPs) for geometric correction of the GPS module, for example 5 GCPs. The system can include a high-precision positioning receiver to measure respective locations of the GCPs based on a multi-band global navigation satellite system (GNSS), e.g., a real-time kinetic (RTK) positioning receiver, with centimetre level precision, e.g., an accuracy of 0.02 m in planimetry and 0.03 m in altimetry. The positioning receiver may be an off-the-shelf receiver. The method may include installing the GCPs adjacent to or in the field site, and measuring the GCP locations within a day of acquiring the images, e.g., on the same day. The GCPs may be installed such that there is one GCP in a centre of the field site, one GCP at each of the four corners of the field site.

The system includes a computing system configured to receive the acquired images (i.e., the aerial multispectral images) from the aerial data acquisition system.

The computing system is configured to process the acquired images for modelling the DW and the FW by performing a data-processing method illustrated in FIG. 2. As shown in FIG. 2, the data-processing method includes:
a. in an upload step, receiving the acquired images as raw images from the multispectral sensor, and receiving the logs from the DLS corresponding to the raw images;
b. in a photogrammetry step, geometrically and radiometrically correcting the raw images;
c. in an SfM step, generating the orthomosaic, the DSM and the DTM;
d. in a VI generation step, generating a plurality of vegetation indices (VIs);
e. in a CHM step, generating the CHM;
f. in a CC step, generating the CC;
g. in a CV step, generating the CV;
h. in a DW step, generating the DW; and
i. in a FW step, generating the FW.

In the photogrammetry step, the photogrammetry application is used to correct the raw images (i.e., the surface radiance measurements) for the influence of incident radiation. In the photogrammetry step, the DNs are converted into absolute surface reflectance values (i.e., a component of the surface radiance independent of the incident radiation/ambient illumination) using: a linear empirical relationship between the DNs and the surface reflectance (wherein the linear relationship is determined by multispectral sensor images of the standardised reflectance panels under consistent illumination), and a time-dependent factor using the logs from onboard DLS sensor to account for changes in irradiation during the acquisition of the images. In the photogrammetry step, the computing system corrects optical (filters and lenses) aberrations and vignetting effects to maintain a consistent spectral response between images. The photogrammetry step may use an off-the-shelf photogrammetry application, e.g., Pix4D.

In the SfM step, composite images (of the orthomosaic, the DSM and the DTM) are generated by stitching hundreds of different calibrated images captured from mutually separate, individual flight missions, e.g., using the photogrammetry application. The SfM step combines the large number of images from a plurality of UAV missions, e.g., based on an example SfM steps described in Harwin et al (Harwin, S.; Lucieer, A. ‘Assessing the Accuracy of Georeferenced Point Clouds Produced via Multi-View Stereopsis from Unmanned Aerial Vehicle (UAV) Imagery’ in ‘Remote Sensing’ 2012, 4, 1573-1599, doi:10.3390/rs4061573). The SfM step includes a feature matching step using a scale-invariant feature transform (SIFT) to create optimized resection geometry for improving initial multispectral sensor position accuracy obtained through the recorded GPS tags. The SfM step includes optimizing the multispectral sensor parameters based on any matched triangulated target points between multiple images, wherein the number of matched points can be selected, e.g., at 10,000 points. The SfM step includes a bundle adjustment step to generate a sparse model that contains generalized keypoints that connect the images. The SfM step includes adding a plurality of fine-scale keypoints during reconstruction of a dense model, which may be crucial in improving geometric composition of the composite images. The SfM step includes using the known GCP locations (also referred to as “GCPs”) of the GCPs in the images collected during the aerial survey to geometrically register the orthomosaic and the models. The SfM step runs on a selected ‘reference’ band, which can be the ‘green’ bands of the multispectral images as the raw images include primarily vegetation features. The SfM step connects identical features in the overlapping portion of adjacent images using the computed keypoints. The SfM step produces the composite reflectance orthomosaic, exported in rasterized (.tif) format. The SfM step recomputes bundle block adjustment to optimize the orientation and positioning of the underlying densified point cloud. The SfM step applies noise filtering to generate the DSM and the DTM. The SfM step applies a sharp surface smoothing to retain crop surface boundaries when generating the DSM and the DTM. The SfM step produces the DSM and the DTM of the field site exported in rasterized (.tif) format. The SfM step resamples the exported layers, namely the orthomosaic, the DSM and the DTM, using an inverse distance weighting function to a 2-cm ground sampling distance (GSD) to provide consistent pixel dimensions.

The spectral and structural (DSM and DTM) layers obtained from the multispectral sensor are used to compute different intermediate layers which were fused at multiple processing levels in the three fusion steps.

The VI generation step uses the orthomosaic—i.e., the spectral reflectance images from the SfM step—to generate a plurality of values for vegetation indices (VIs). Each VI may be regarded as a spectral transformation of two or more multispectral bands to highlight a property of the crops. The VI values may be used for a reliable spatial and temporal inter-comparison of crop photosynthetic variations and canopy structural profiles. The VIs are immune from operator bias or assumptions regarding land cover class, soil type, or climatic conditions, therefore may be suitable in high-throughput phenotyping. Seasonal, interannual, and long-term changes in crop structure, phenology, and biophysical parameters could be efficiently monitored using the VIs measured from a plurality of surveys over time. The VI generation step may compute a plurality of Vis, e.g., 12, using one or more of the equations listed in Table 1. The VI generation step generates at least the optimized soil adjusted vegetation index (OSAVI) in an OSAVI layer using known relationships, e.g., described in Fern et al. (Fern, R. R.; Foxley, E. A.; Bruno, A.; Morrison, M. L. ‘Suitability of NDVI and OSAVI as estimators of green biomass and coverage in a semi-arid rangeland’ in ‘Ecological Indicators’ 2018, 94, 16-21, doi:10.1016/j.ecolind.2018.06.029) or Rondeaux et al. (Rondeaux, G.; Steven, M.; Baret, F. ‘Optimization of soil-adjusted vegetation indices’ in ‘Remote Sensing of Environment’ 1996, 55, 95-107, doi:Doi 10.1016/0034-4257(95)00186-7).

TABLE 1
multispectral vegetation indices derived and tested for assessment of
biomass:

| Index | Equation | Reference |
|---|---|---|
| Normalized difference | $NDVI = \frac{NIR - RED}{NIR + RED}$ | (Rouse et al. 1974) |
| vegetation | | |
| index | | |
| Enhanced vegetation | $EVI = \frac{2.5 ( NIR - RED )}{( NIR + 6 \times RED - 7.5 \times BLUE ) + 1}$ | (Huete et al. 2002) |
| index | | |
| Green normalized | $GNDVI = \frac{NIR - GREEN}{NIR + GREEN}$ | (Gitelson and Merzlyak 1998) |
| difference | | |
| vegetation | | |
| index | | |
| Normalised difference | $NDRE = \frac{NIR - RE}{NIR + RE}$ | (Barnes et al. 2000) |
| red-edge | | |
| index | | |
| Renormalized difference vegetation index | $RDVI = \frac{NIR - RED}{\sqrt{NIR + RED}}$ | (Roujean and Breon 1995) |
| Optimized soil adjusted | $OSAVI = 1.6 [ \frac{NIR - RED}{NIR + RED + 0.16} ]$ | (Rondeaux, Steven, and |
| vegetation | | Baret 1996) |
| index | | |
| Modified simple ratio | $MSR = \frac{( NIR / RED ) - 1}{\sqrt{( NIR / RED ) + 1}}$ | (Chen 1996) |
| Modified | MCARI1 = 1.2[2.5(NIR − GREEN) − | (Haboudane |
| chlorophyll | 1.3(RED − GREEN)] | et al. 2004) |
| absorption | | |
| ratio index 1 | | |
| Modified chlorophyll absorption ratio index 2 | $MCARI 2 = \frac{3.75 ( NIR - RED ) - 1.95 ( NIR - GREEN )}{{( 2 \times NIR + 1 )}^{2} - ( 6 \times NIR - 5 \sqrt{RED} ) - 0.5}$ | (Haboudane et al. 2004) |
| Modified | MTVI1 = 1.2[1.2(NIR − GREEN) − 2.5(RED − GREEN)] | (Haboudane |
| triangular | | et al. 2004) |
| vegetation | | |
| index 1 | | |
| MTVI2 | $MTVI 2 = \frac{1.8 ( NIR - GREEN ) - 3.75 ( RED - GREEN )}{\sqrt{{( 2 \times NIR + 1 )}^{2} - ( 6 \times NIR - 5 \sqrt{RED} ) - 0.5}}$ | (Haboudane et al. 2004) |
| Pigment specific | $PSSRA = \frac{NIR}{RED}$ | (Blackburn 1998) |
| simple ratio | | |
| for | | |
| chlorophyll a | | |

where the References are:
a. Barnes, E M, T R Clarke, S E Richards, P D Colaizzi, J Haberland, M Kostrzewski, P Waller, C Choi, E Riley, and T Thompson. 2000. Coincident detection of crop water stress, nitrogen status and canopy density using ground based multispectral data. Paper presented at the Proceedings of the Fifth International Conference on Precision Agriculture, Bloomington, MN, USA.
b. Blackburn, George Alan. 1998. “Quantifying chlorophylls and caroteniods at leaf and canopy scales: An evaluation of some hyperspectral approaches.” Remote Sensing of Environment 66 (3):273-85.
c. Chen, Jing M. 1996. “Evaluation of Vegetation Indices and a Modified Simple Ratio for Boreal Applications.” Canadian Journal of Remote Sensing 22 (3):229-42. doi: 10.1080/07038992.1996.10855178.
d. Gitelson, Anatoly A., and Mark N. Merzlyak. 1998. “Remote sensing of chlorophyll concentration in higher plant leaves.” Advances in Space Research 22 (5):689-92. doi: https://doi.org/10.1016/S0273-1177(97)01133-2.
e. Haboudane, Driss, John R. Miller, Elizabeth Pattey, Pablo J. Zarco-Tejada, and Ian B. Strachan. 2004. “Hyperspectral vegetation indices and novel algorithms for predicting green LAI of crop canopies: Modeling and validation in the context of precision agriculture.” Remote Sensing of Environment 90 (3):337-52. doi: http://dx.doi.org/10.1016/j.rse.2003.12.013.
f. Huete, A., K. Didan, T. Miura, E. P. Rodriguez, X. Gao, and L. G. Ferreira. 2002. “Overview of the radiometric and biophysical performance of the MODIS vegetation indices.” Remote Sensing of Environment 83 (1-2):195-213. doi: http://dx.doi.org/10.1016/S0034-4257(02)00096-2.
g. Rondeaux, G., M. Steven, and F. Baret. 1996. “Optimization of soil-adjusted vegetation indices.” Remote Sensing of Environment 55 (2):95-107. doi: Doi 10.1016/0034-4257(95)00186-7.
h. Roujean, Jean-Louis, and Francois-Marie Breon. 1995. “Estimating PAR absorbed by vegetation from bidirectional reflectance measurements.” Remote Sensing of Environment 51 (3):375-84. doi: https://doi.org/10.1016/0034-4257(94)00114-3.
i. Rouse, J W, R H Haas, J A Schell, D W Deering, and J C Harlan. 1974. “Monitoring the vernal advancement of retrogradation of natural vegetation (p. 371).” Greenbelt, MD: NASA/GSFC (Type III, Final Report).

The CHM step performs a pixel-wise subtraction of the DTM altitudes from the DSM altitudes to generate the crop height model (CHM), representing the relief of the entire crop surface. The accuracy of the CHM computed using the SfM step may rely on interacting factors including the complexity of the visible surface, resolution and radiometric depth, sun-object-sensor geometry, and type of sensor. As the canopy surface, e.g., for wheat, may be very complex containing reflectance anisotropy and micro-relief height variation, a moving filter (e.g., a 3×3 pixel local maximum moving filter) may be applied on the CHM layer to enhance the highest peaks and reduce the micro-variation. The implemented filter may move the pre-defined window over the CHM and replace the centre pixel's value with the maximum value in the window if the centre pixel is not the maximum in the window.

The CC step uses OSAVI to suppress background soil spectrum to improve the detection of vegetation. The CC step fuses the OSAVI layer and the CHM layer to create a CC layer to mask the extent of the vegetation for individual plots across all time points. In the CC step, individual segmentation layers are prepared for OSAVI and CHM using a dynamically computed threshold using an adaptive thresholding method for binarization in image processing, e.g., the Otsu method (described in Otsu, N. ‘A threshold selection method from gray-level histograms’ in ‘IEEE transactions on systems, man, and cybernetics’ 1979, V9, 62-66), in which the threshold is computed adaptively by minimizing intra-class intensity variance (i.e., between index values for OSAVI and height levels for CHM), or equivalently, by maximizing inter-class variance. The adaptive thresholding method returns a single threshold that separate pixels into two classes: vegetation and background. The adaptive thresholding method may filter unwanted low-value OSAVI and CHM pixels, corresponding to minor unwanted plants such as weeds or undulated ground profile respectively. The CC step generates a pixel-wise product of the segmented OSAVI and CHM pixels to prepare the CC mask corresponding to vegetation, e.g., wheat. The CC step uses the fusion of the OSAVI layer and the CHM layer to resolve limitations that each layer has on its own. The OSAVI layer provides the ‘greenness’ of the crop (which ‘greenness’ drops during flowering and after maturity). The CHM provides the crop relief, which may be immune to changes in ‘greenness’ (so applicable during flowering and post-emergence of maturity), but suffers when the plants are too small (e.g., less than 5 cm approximately) as the crop canopy may be too fragile for the SfM step to generate a dependable CHM. These independent limitations are resolved in the CC step through the fusion of the OSAVI and CHM layers, improving classification of the CC of the crop.

The crop volume (CV) step computes the CV by multiplying the CHM and the CC pixelwise, then by summing the volume under the crop surface, e.g., using the formula in Equation 1:

$$CV = {\sum }_{p i x e l ( i , j ) = ( 0 , 0 )}^{p i x e l ( i , j ) = ( m , n )} {\vert CHM \times CC \vert}_{i , j} \qquad ( 1 )$$

$$or$$

$$CV = {\sum }_{i = 1}^{i = m} {\sum }_{j = n}^{j = n} C H {M}_{i , j} \times C {C}_{i , j} \qquad ( 1 )$$

where i and j represent the row and column number of the image pixels for an m×n image, i.e., the size of an individual plot. The multiplication of the CHM with the CC layer in the CV step may mitigate errors from ground surface undulations and edge-effects in surface reconstructed in the SfM step.

The dry weight (DW) step uses a linear model relationship, e.g., as in Equation (2), to compute the DW:

DW=α·CV+β (2)

where coefficients slope (α) and bias (β) are measured parametrically using measured (ground truth) DW values, which may be constant for a selected crop type (e.g., wheat) and constant sowing rate. The DW step provides DW using CV through non-invasive and non-destructive means applicable for field high-throughput phenotyping.

The fresh weight (FW) step computes the FW by fusing the CV with the set of derived VIs. CV is a canopy structural metric computed through the SfM step and estimates the dry tissue content or DW, but is void of the ability to infer the fresh tissue water content or FW; however, VIs are reflectance-derived biophysical parameters having the ability to infer photosynthetic variations and related water potential in vegetation. The fusion of the CV and the VIs resolves the limitations of the individual parameters. The fusion in the FW step can use a mathematical product in a relationship shown in Equation 3:

FW=α·CV×VIs+β (3)

where the slope (α) and the bias (β) are the same as in Equation 4, and where the model coefficient values (which are the slope (α) and the bias (β)) vary corresponding to the different VIs.

The hereinbefore-described steps of the data-processing module are performed by the computing system executing machine readable instructions (in non-transient storage media) that are defined by the hereinbefore-described steps. The instructions can be generated from source code written in Python 3.7.8 (Python Software Foundation. Python Language Reference) using source packages including os, fnmatch, matplotlib, numpy, Fiona, shapely, skimage, opencv2, rasterio, and geopandas.

A shapefile (.shp) consisting of the individual field plot information can be created in the method using an off-the-shelf application.

The coded method steps of the data-processing module include generation of the intermediate geospatial layer corresponding to individual traits, clipping the layers to plot geometries, summarizing the traits in individual plots, and analyzing and validating the summarized traits.

The method and system may be used for phenotyping germplasm in wheat and other crop species. The method and system may be used for estimating crop parameters such as for AGB mapping, and for measuring leaf area index, chlorophyll, nitrogen content, lodging, plant density estimates, counting wheat-ear numbers, etc. The method and system may be substantially accurate and may correlate with AGB in reproductive and post-reproductive growth stages (i.e., the example model relationship is valid across different growth stages including during and post-reproductive periods) in breeding trials with wide diversity in growth responses between genotypes (i.e., a variety of genotypes with wide diversity in growth).

The method and the system may improve upon alternative high-throughput technologies that use reflectance spectra because reproductive growth does not relate to reflectance spectra, and multiple growth stages exist concurrently in diverse genotypes. The method and the system may improve upon traditional technologies using vegetation indices (VIs) that may saturate at high canopy coverage (including in the red and near-infrared spectral bands), that may fail to capture the plants' vertical growth profile, and that may lose their sensitivity in the reproductive growth stages.

The system and method can provide or support high-throughput phenotyping that is more cost and time-efficient than traditional phenotyping, thus supporting crop breeding programmes. Relevant application areas may include nitrogen use efficiency, water use efficiency, heat tolerance, salt tolerance, insect damage resistance, yield forecasting, and other allied application areas. The fusion system and method may be time-efficient and cost-effective compared to other methods employing secondary sensor systems such as SAR and LiDAR in addition to a multispectral sensor or a dedicated hyperspectral sensor to compute narrow band VIs. The fusion system and method include the fusion of complementary spectral and structural information derived using the same multispectral sensor to provide a suitable and robust alternative to traditional methods involving purely spectral VIs. The fusion-based data-processing method uses intermediate parameters or metric or traits (i.e., the VIs, the CHM, the CC, and the CV), and the interaction between these intermediate parameters at different levels, to provide improved accuracy of parameters at successive steps/stages, thereby developing the model relationship for DW and FW. As described herein, the fusion steps are: (i) the logical ‘OR’ operation between the OSAVI segment and the CHM segment layer to derive the CC; (ii) the mathematical product between the CC and the CHM followed by summation over the plot area to calculate the CV relating to the DW, and (iii) the multiplication between the CV and the VIs to retrieve the FW (as shown in FIG. 2). The estimation of DW by using CV and FW by using CV×VIs could be understood by considering that with a constant plant density for a crop, the density factor (Dₜᵢₛₛᵤₑ) and air space within the canopy (Vₐᵢᵣ) could be assumed to be constant; therefore, DW of the tissue should linearly correlate with CV (R²=0.96), and while water is present inside the ‘plant tissue’, it may not significantly influence CV, so as such may not be used robustly to measure FW (e.g., R²=0.62). VIs, on the other hand, are influenced primarily by the chlorophyll content or greenness of the plant, which in turn are influenced by photosynthetic potential and water uptake during the growth. In other words, high FW can imply high water uptake in tissue, better photosynthetic ability, and generally plants with more greenness corresponding to higher values of VIs. However, the amount of plant matter or CV undergoing the photosynthesis process remains unaccounted for, which multiplying CV with VIs can account for, increasing the simple linear model relationship in measuring FW (R²>0.8 for all CV×VIs combinations in FIG. 6(b); with best tested R²=0.89 for CV×EVI in FIGS. 5(b) and 5(c)).

The generated CHM and CC may be beneficial agronomic traits. Traditionally, for short crops such as wheat, plant height is measured using a ruler in the field by selecting a single or a few representative plants to represent the canopy height. The method is labour intensive, time-consuming and expensive for large breeding trials. Measuring variation in crop height associated with growth at finer temporal rates (less than once per week) remains largely impractical in widely distributed field trials. The CHM layer derived herein achieved satisfactory model correlation in estimating crop height in plots (as shown in FIG. 3), acceptable to measure the fine-level of height growth with genotypic variation in a population. The CC or crop fractional cover is an important phenological trait of crops, which can be used as an indicator of early vigour and crop growth rates during the vegetative growth stages. The computed CC layer may be more reliable and advantageous than subjective visual scores (as shown in FIG. 4 and Table 2). Inter-plot spacing may benefit extraction of the DTM, thereby improving the calculation of the CHM and the CC. Increasing the inter-plot spacing may, therefore, be advantageous for accuracy while reducing the field use efficiency. Additional factors such as variation in soil water content upon rain or irrigated conditions, and presence of vegetation, e.g., crop over-growth or weed in inter-plot spacing, may impact the construction of the CHM and the CC, and reduce their respective correlation with ground truth crop height and coverage. The fusion method may therefore include performing the image acquisition when the crop is dry from applied water, i.e., avoiding for image acquisition after rain or irrigation. Use of the described method allows CV to be used as a proxy to DW, and CV×EVI to be used as a proxy to FW, thus the metrics CV and CV×EVI could certainly be used proxies to screen crop genotypes with higher or lower biomass and monitor their growth patterns over time.

### Experimental Examples of Fusion Method

In an example, the implemented method outperformed commonly used vegetation indices (VIs) derived from multispectral orthomosaics in all growth conditions and variability, e.g., spectral VI based approaches to model biomass/AGB using the simple regression techniques.

In an example, the intermediate metrics, CHM (R2=0.81, SEE=4.19 cm) and CHM (OA=99.2%, K=0.98) correlated well with equivalent ground truth measurements, and the metrics CV and CV×VIs were used to develop an effective and accurate model relationship with FW (R2=0.89 and SEE=333.54 g/m2) and DW (R2=0.96 and SEE=69.2 g/m2).

An experimental example of the method and system was used at and for a site located in a mild temperate climate that receives approximately 448 mm average rainfall annually and has predominantly Self-mulching Vertosol soil type. The experiment comprised 20 wheat genotypes with four replications, each planted in 5m×1 m plot, with a density of approximately 150 plants m². Five aerial flights were undertaken at 30, 50, 90, 130 and 160 days after sowing (DAS). For comparison with the experimental system, a range of in situ data were collected concurrently with use of the method, including: visual assessment of plant condition in plots, measurements of plant height at two time points (130 and 160 DAS), and harvesting plot replicates at four time points (50, 90, 130 and 160) for destructively measuring FW and DW biomass.

The experimental system included the data acquisition system.

In an experimental example, the plant heights of four replicates of 20 lines in 80 plots (i.e., 20 wheat genotypes, each with four replications, planted in 5m×1 m plot, with a density of approximately 150 plants per m²) were manually measured at the two time points on X DAS and Y DAS, totaling 160 ground truth height observations. Four representative wheat plants from each experimental plot were measured using a measuring staff from the ground level to the highest point of the overall plant, the average of the four height measurements was used as a representative ground truth measurement for the corresponding plot. Plant heights in the breeding population were ranged from 54 to 91 cm on 130 DAS and 62 to 98 cm on 160 DAS with a normal distribution (Kolmogorov-Smirnov test, P<0.001). The mean plant heights were 71.8 and 78.9 cm on 130 DAS and 160 DAS, respectively. To evaluate SfM derived CHM's performance with respect ground truth plot height measurements a correlation-based assessment was sought (FIG. 3). The assessment achieved a strong and statistically significant (p-value<1.8×10⁻⁹²) linear relationship between CHM and ground truth plot height with a coefficient of determination (R²) of 0.81 and a standard error estimate (SEE) of 4.19 cm in wheat. To minimize differences due to plant growth, the field measurements were carried out on the same days of the aerial surveys. Unlike the highest points measured during ground-based surveys, the CHM represents the entire relief of the crop surface, therefore, the CHM was found to be about 34 cm systematically lower than the actual canopy height. Images from UAVs are characterized by low-oblique vantage, benefiting in the accurate estimation of height in wheat plots. Human error may have contributed in the collection of the ground truth plot height, especially for selecting representative wheat plants where intra-plot variation exists.

In an experimental example, to potentially validate the fusion-based steps described hereinbefore, FIG. 4 shows the classified CC and CC×VIs images against RGB composite images generated using multispectral bands blue (475 nm), green (560 nm) and red (668 nm). A section of the entire field trial was focused including three varieties with different fraction density, plant height and variable growth stage effect. The hereinbefore-described data-processing method performed well throughout the vegetation part of the plot with minor classification challenges around the edges of vegetation. The characteristics of vegetation and ground were too similar along the borders, so it was difficult to achieve good results in these areas. The fractional nature of wheat canopy affected the accuracy due to the presence of noisy pixels comprising of mixed spectra from both wheat and ground and a limitation of the SfM step to resolve the finer details along high-gradient relief variations.

In an experimental example, a more rigorous approach to evaluate the achieved classification accuracy for the CC layer was performed through a comparison of CC classified labels against ground truth across randomly selected locations using a confusion or validation matrix (shown in Table 2). Over the five time points, a total of 1500 ground truth points (i.e., 300 points in each time point) were generated between the two classes: wheat CC and ground using an equalized stratified random method, creating points that are randomly distributed within each class, where each class has the same number of points. The ground truth corresponding to each point for validation was captured manually through expert geospatial image interpretation training using high-resolution (2 cm) RGB composite orthomosaic images. Accuracy measures namely producer's accuracy, user's accuracy, overall accuracy (OA) and kappa coefficient (κ) were computed using the confusion matrix. The classification class CC, achieved a user's accuracy of 98.9%, producer's accuracy of 99.4% and overall accuracy (OA) of 99.2%. In traditional accuracy classification, the producer's accuracy or ‘error of omission’ refers to the conditional probability that a reference ground sample point is correctly mapped, whereas the user's accuracy or ‘error of commission’ refers to the conditional probability that a pixel labelled as a class in the map actually belongs to that class. Overall accuracy refers to the percentage of classified map that is correctly allocated, used as a combined accuracy parameter from a user's and producer's perspective. In addition to the traditional estimates, the classification achieved a kappa coefficient (κ) of 0.98, which is an indicator of agreement between classified output and ground truth values. A kappa value ranges between 0 and 1 representing the gradient of agreement between ‘no agreement’ and ‘perfect agreement’.

TABLE 2
classification accuracy of crop coverage
(CC) across all growth stages:

| | | Crop | | User's | |
|---|---|---|---|---|---|
| Class | Ground | Coverage | Total | Accuracy | Kappa |
| Ground | 746 | 4 | 750 | 99.4% | |
| Crop Coverage | 8 | 742 | 750 | 98.9% | |
| Total | 754 | 746 | 1500 | | |
| Prod.'s Accuracy | 98.9% | 99.4% | | 99.2% | |
| Kappa | | | | | 0.98 |

In an experimental example, the hereinbefore-described modelling of the DW using the CV was compared against traditional VI based approaches. The comparison shows the R² values obtained for predicted vs. observed DW values when using CV and VIs, across different time points. The linear regression demonstrates that the degree of correlation (in terms of R²) for the VI based approached in modelling DW become less accurate at progressive time points from sowing, while the accuracy of CV based approach for modelling DW remains consistently high (as shown in FIG. 5(a)). For the interpretation of the results, correlations were considered hereafter as low (R₂<0.70), moderate (0.70≤R²<0.85) and high (R²≥0.85). This result was influenced by the fact that research plots growing different genotypes of wheat have variable growth trajectories influenced by the genomics and environmental effects, common in high-throughput phenotyping research; exhibiting variation in reflectance response which is limiting to the accuracy of the linear model. The CV, on the other hand, is derived through structural means using SfM and is substantially immune to variation in spectral properties of plants over different growth stages across research plots. Of the four time points studied in the experiment for biomass estimation, at the earliest time point, the genotypes in different plots are in similar overall growth stages as such the VI derived model prediction is well accurate with high R² values. At later time points, genotypes attained different growth stages influencing the spectral signatures and VIs in the process, thereby lowering their R². When data from all the time points in the experiments were combined, ground DW was still accurately predicted using CV, whereas traditional VIs failed considerably exhibiting low R² values (as shown in FIG. 5(b)). The result might seem contradictory to previous studies demonstrating high prediction potential of VIs particularly related to structural characteristics of plants, i.e., NDVI, GNDVI, OSAVI, MTVI1 and MTVI2, which had established a successful relationship with biomass under restricted complexities, i.e., either on a single genotype in a field or in a single time point. The experimental example study indicates that CV derived using the fusion method is consistent with genotypic variation and across different time points, as an accurate predictor (R²=0.96 and SEE=69.2 g/m²) of DW with statistical significance (p-value<0.001, or <2.4×10⁻¹⁸) (as shown in FIG. 5(c)).

In an experimental example, the modelled FW using CV×VIs products was evaluated using different CV and VIs combinations, and against independent VIs. For evaluating different CV×VIs combinations, a plot of the corresponding R² values obtained for predicted vs. observed FW values across different time points was used (as shown in FIG. 6(a)). The performance of three combinations, CV×GNDVI, CV×EVI and CV×NDRE was found to be consistently higher across different time points from sowing to post maturity, compared to the other CV×VIs. The performance of CV×EVI was best amongst the three tested CV×VIs combinations for FW estimation. When data from all the four time points in the experiments for biomass estimation were combined, the CV×EVI was again found to outperform other CV×VIs (as shown in FIG. 6(b)). Therefore, CV×EVI was used as an estimator to model FW computation (as shown in FIG. 6(c)). The estimator achieved a strong (R²=0.89 and SEE=333.54 g/m²) and statistically significant (p-value<0.001, or <2.2×10⁻²²) linear relationship with ground truth measurements of FW in wheat. The regression analysis demonstrates that the R² for the original VI-based approaches in modelling FW increases significantly for all VIs when coupled with CV (as shown in FIG. 6(b)). As mentioned hereinbefore, the fusion of CV×VIs in the described data-processing method takes advantage of both spectral and structural information provided by VIs and CV respectively, whereas original VIs are unable to account for structural variations between different genotypes in high-throughput phenotyping.

In an experimental example, the DW and the FW generated from the method were used in scoring the performance of selected genotypes. Predicted crop biomass (DW and FW) estimated across the four dates showed expected and consistent growth trends for wheat genotypes (as shown in FIG. 7). Most varieties showed a steady growth of DW until the third time point, followed by nearly exponential growth between the third and fourth time point (as shown in FIG. 7(a)). The FW, on the other hand, followed a steady growth till fourth time point (as shown in FIG. 7(b)). Importantly, the derived multitemporal biomass models were able to capture this trend in plant development. Amongst all the varieties Carnamah achieved highest and Derrimut achieved the lowest DW and FW. Genotypes Sunvale, Volcani DDI, Gladius, Ellison, Hartog, Ventura, Carnamah, EGA Gregory, Kennedy and Sunco demonstrated an early vigour, producing comparatively more biomass during early to mid-vegetative growth. Overall, Carnamah produced the most biomass, while Derrimut produced the lowest DW and FW.

### Overview of Neural Network Method

Disclosed herein is a method for image-based remote sensing of crop plants. Also disclosed herein is a system configured to perform the method.

The method (also referred to herein as the ‘neural network method’ or NN method) includes:
a. acquiring images (also referred to as “training images” in a “training data set) of the crop plants from a camera flown over the crop by an unmanned/uncrewed aerial vehicle (UAV);
b. forming an artificial neural network (ANN) by:
   i. uploading the (training) images to a neural architecture search (NAS) module to select a neural architecture for the artificial neural network (ANN), and
   ii. training the ANN using the (training) images; and
c. using the trained ANN to identify and/or measure one or more phenotypic characteristics of the crop plants in the images by classification and/or regression.

The crop plants may include wheat. The phenotypic characteristics of the crop plants include whether or not there is wheat lodging (i.e., a classification task), and/or a level (i.e., measure) of the wheat lodging using a lodging estimator of levels in the images, i.e., a regression task.

The system (also referred to herein as the ‘neural network system’ or NN system) includes the NAS-generated ANNs for the image-based remote sensing of crop plants.

The neural architecture search (NAS) module selects a well-performing neural architecture through selection and combination of various basic predefined modules from a predefined search space. The predefined modules are pre-existing modules configured to be combined in variable configurations to form a variety of convolutional neural networks (CNN). The NAS module is configured to: select a plurality of mutually different combinations of the predefined modules to define a corresponding plurality of mutually different CNNs; test the plurality of mutually different CNNs; and select at least one of the plurality of mutually different CNNs based on performance of the CNNs in the test.

Due to the NAS, the step of forming the ANN is automated, and thus this step may be referred to as including “automated machine learning” or “AutoML”.

The NN method and system may be used to provide high-throughput image-based plant phenotyping.

The NN system includes an aerial data acquisition system for the acquiring of the images, the aerial data acquisition system including:
a. an optical camera to acquire the images;
b. the UAV with a gimbal mount; and
c. a geotagging module to geotag each image.

The UAV is configured to support a payload of at least 1 kg, or at least 6 kg, or between 1 kg and 6 kg. The UAV may be an off-the-shelf UAV in the form of a quadcopter. The data acquisition system includes a gimbal bracket that fastens and attaches the optical camera to the gimbal mount. The optical camera may have a 35.9 mm×24.0 mm sensor size, and/or a 42.4 megapixels resolution. The optical camera may have a 55 mm fixed focal length lens. The optical camera may have a 1 second interval shooting with JPEG format in shutter priority mode. The camera may be an off-the-shelf multispectral camera. The geotagging module may be an off-the-shelf geotagging module.

The NN system includes one or more (e.g., seven) black and white checkered square panels (38 cm×38 cm) distributed in the field to serve as ground control points (GCPs) for accurate geo-positioning of images. The method may include installing the GCPs adjacent to or in the field site, and measuring the GCP locations within a day of acquiring the images, e.g., on the same day. The GCPs may be installed such that there is one GCP in a centre of the field site, and at least one GCP on each edge of the field site (as shown in FIG. 1). The NN system includes a real-time kinematic global positioning system (RTK-GPS) receiver to record the centre of each panel with <1 centimetre accuracy. The positioning receiver may be an off-the-shelf receiver.

The NN system includes a computing system configured to receive the acquired images (i.e., the aerial multispectral images) from the aerial data acquisition system. The computing system is configured to process the acquired images by performing pre-processing steps. The pre-processing steps include: generating an orthomosaic image of the acquired images with the coordinates of the GCPs used for geo-rectification (e.g., an orthomosaic with a ground sampling distance (GSD) of 0.32 cm/pixel) using an off-the-shelf software application; and clipping individual plot images and storing them in TIFF format from the orthomosaic using a field plot map with polygons corresponding to the selected plot dimensions (e.g., 5 m×1 m for the plot in FIG. 8) using an off-the-shelf software application.

As shown in FIG. 9, the NN method includes a visual assessment step (“lodged”) that includes manually (i.e., by a person) classifying the acquired images to generate a training data set. For example wheat crop images, the lodging status may be determines to be lodged (yes) or non-lodged (no) based on visual inspection of the images and/or corresponding ground truth information (“ground truth”) to the geotagged image locations

As shown in FIG. 9, the NN method include a scoring step (“lodging score”) that includes manually selecting scores (numerical values) for the respective acquired images. Selecting the scores may include selecting an area (e.g., lodged area) and a level (e.g., a severity of lodging) for each acquired image. For wheat images, lodging severity values of 1 to 3 may be manually selected (corresponding to three main grades of lodging) based on the manually determined inclination angle between the wheat plant and the vertical line as follows: light lodging (severity 1; 10 deg-30 deg), moderate lodging (severity 2; 30 deg-60 deg) and heavy lodging (severity 3; 60 deg-90 deg). For wheat images, the lodged area (%) may be determined visually from the plot images as the percentage of area lodged in the plot in proportion to the total plot area. The scoring step may include determining a score based on the selected area and level. For example, for wheat, a derived lodging score may be defined to range between values of 1-100, with a score of 100 indicating that the entire plot was lodged with heavy lodging based on the following equation:

$$Lodging score = \frac{Lodging severity}{3} \times Lodged area ( \% )$$

The step of forming the ANN is executed in the computing system of the NN system. The computing system includes machine readable instructions in machine-readable storage media (e.g., in RAM, a hard disk or cloud server) that, when executed by the computing system, perform the data-processing method. The instructions can be generated from source code written in Python 3.7. The computing system may include or access a publicly accessible machine-learning framework, e.g., AutoKeras. The computing system may include a high-speed graphical processing unit (GPU), e.g., with 24 GB of memory.

The NN system and method may be fast enough for real-time inferencing, e.g., with example interference speeds under 10 ms.

### Experimental Examples of Neural Network Method

In an experimental example for wheat lodging assessment with UAV imagery, the NN method outputs from the image classification and regression tasks were compared to outputs from a manual approach using transfer learning with publicly available CNNs (including VGG networks, residual networks (ResNets), InceptionV3, Xception and densely connected CNNs (DenseNets)), pretrained on the publicly available ImageNet dataset. For image classification, plot images were classified as either non-lodged or lodged; for image regression, lodged plot images were used as inputs to predict lodging scores. The best tested classification performance of 93.2% was jointly achieved by transfer learning with Xception and DenseNet-201 networks. In contrast, the best in test example NN method and system (based on AutoKeras, from 100 trials) achieved an accuracy of 92.4%, which was substantially the same as those obtained by transfer learning with ResNet-50. In another text, the example NN method and system had the best in test accuracy (92.0%) compared to the ResNet-50 (90.4%) in image classification which assigned wheat plot images as either lodged or non-lodged. For image regression, lodged plot images were used as inputs to predict lodging scores. The example NN method and system performed better (R²=0.8273, RMSE=10.65, MAE=8.24, MAPE=13.87%) in this task compared to the ResNet-50 (R²=0.8079, RMSE=10.81, MAE=7.84, MAPE=14.64%). In another test, the best in test performance (R2=0.8303, RMSE=9.55, MAE=7.03, MAPE=12.54%) was obtained using transfer learning with DenseNet-201, followed closely by the example NN method and system (AutoKeras, R2=0.8273, RMSE=10.65, MAE=8.24, MAPE=13.87%) with the model discovered from 100 trials. In both image classification and regression tasks, transfer learning with DenseNet-201 achieved the best in test results. DenseNet can be considered as an evolved version of the ResNet, where the outputs of the previous layers are merged via concatenation with succeeding layers to form blocks of densely connected layers; however, similarly to image classification, the DenseNet-201 had the slowest inference time (117.23±15.25 ms) on the test dataset in image regression, making it potentially less suitable for time-critical applications such as real-time inferencing. In comparison, the example NN method and system (AutoKeras) resembled a mini 8-layers Xception model (207,560 parameters) and had the fastest inference time (2.87±0.12 ms) on the test dataset, which was ˜41-fold faster compared to the DenseNet-201. In its original form, the Xception network is 71-layers deep (˜23 million parameters) and consists of three parts: the entry flow, middle flow and exit flow, with ˜10-fold faster inference speed (8.46 ms), making it suitable for real-time inferencing. These three parts and two key features of the Xception network, namely the depthwise separable convolutions and skip connections originally proposed in ResNet were discernable from the mini Xception model.

In an experimental example during the winter-spring cropping season of 2018, wheat seeds were sown to a planting density of 150 plants/m² in individual plots measuring 5 m long and 1 m wide (5 m²), with a total of 1,248 plots (Lat:36°44°35.21″S Lon:142°6′18.01″E), as shown in FIG. 8. Severe wind events toward the end of the cropping season (30 November-9 December) resulted in significant lodging of wheat plots across the experiment. Ground truth labels for “lodged” and “non-lodged” were provided by an experienced field technician and a plant scientist. The high resolution aerial imaging of the wheat plots with the mutually different lodging grades was performed on 11 Dec. 2018 using the NN system. The flight mission was performed at an altitude of 45 m with front and side overlap of 75% under clear sky conditions.

In an experimental example of the image classification, the image dataset consisted of 1,248 plot images with 528 plots identified as non-lodged (class 0) and 720 plots identified as lodged (class 1). Images were first resized (downsampled) to the dimensions of 128 width×128 height×3 channels and these were split 80:20 (seed number=123) into training (998 images) and test (250 images) datasets. For image regression, the 720 resized plot images identified as lodged were split 80:20 (seed number=123) into training (576 images) and test (144 images) datasets. Images were fed directly into the example NN method and system (AutoKeras) without pre-processing. In contrast, images were pre-processed to the ResNet-50 format using the provided preprocess_input function in Keras. For model training on both image classification and regression, the training dataset was split further 80:20 (seed number=456) into training and validation datasets. The validation dataset is used to evaluate training efficacy, with lower validation loss indicating a better trained model. Performance of trained models was evaluated on the test dataset. A custom image classifier was defined using the AutoModel class which allows the user to define a custom model by connecting modules/blocks in AutoKeras (as shown in FIG. 11) such that the user only needs to define the input node(s) and output head(s) of the AutoModel, and the rest is inferred by AutoModel itself. In the experimental example, the input nodes were first an ImageInput class accepting image inputs (128×128×3), which in turn was connected to an ImageBlock class which selects iteratively from a ResNet, ResNext, Xception or simple CNN building blocks to construct neural networks of varying complexity and depth. The input nodes were joined to a single output head, the ClassificationHead class which performed the binary classification (as shown in FIG. 11). The AutoModel was fitted to the training dataset with the tuner set as “bayesian”, loss function as “binary_crossentropy”, evaluation metrics as “accuracy” and 200 training epochs (rounds) for 10, 25, 50 and 100 trials with a seed number of 10. For image regression, the default Autokeras image regression class, ImageRegressor was fitted to the training dataset with the loss function as mean squared error (MSE), evaluation metrics as mean absolute error (MAE) and mean absolute percentage error (MAPE), and 200 training epochs for 10, 25, 50 and 100 trials with a seed number of 45 (as shown in FIG. 11). The performance of the best tested models from 10, 25, 50 and 100 trials were evaluated on their respective test datasets, and exported as Keras models to allow neural network visualization using the open-source tool, Netron. Model inference times were measured using the built-in Python function, timeit and presented as mean±standard deviation in milliseconds (ms).

For comparison with the experimental example, the pretrained CNNs (e.g., ResNet-50) were implemented in Keras as a base model using the provided Keras API with the following parameters: weights=“imagenet”, include_top=False and input_shape=(128, 128, 3) (as shown in FIG. 12). Outputs from the base model were joined to a global average pooling 2D layer and connected to a final dense layer, with the activation function set as either “sigmoid” for image classification or “linear” for image regression. The model was compiled with the batch size as 32, optimizer as ‘Adam’ and corresponding loss functions and evaluation metrics as described hereinafter. Model training occurred in two stages for both image classification and regression tasks: in the first stage (100 epochs), weights of the pre-trained layers were frozen and the Adam optimizer had a higher learning rate (0.1 or 0.01) to allow faster training of the top layers; in the second stage (200 epochs), weights of the pre-trained layers were unfrozen and the Adam optimizer had a smaller learning rate (0.01 or 10\hat{ }(−5)) to allow fine-tuning of the model. Learning rates were optimized for each CNN and the values which provided the best tested model performance are provided in Table 4. Performance of the trained models was evaluated on their respective test datasets as described hereinafter.

Model evaluation metrics were selected to compare the pretrained CNNs (e.g., ResNet-50) with the example NN system and method. For image classification, model performance on the test dataset was evaluated using classification accuracy and Cohen's kappa coefficient (Cohen, J. A Coefficient of Agreement for Nominal Scales. Educational and Psychological Measurement 1960, 20, 37-46). In addition, classification results using ResNet-50 (transfer learning) and the best in test example NN model (from AutoKeras) were visualized using confusion matrices. For image regression, in addition to the mean absolute error (MAE) and the mean absolute percentage error (MAPE) provided by AutoKeras and Keras, the coefficient of determination (R²) and the root mean-squared error (RMSE) were also calculated to determine model performance on the test dataset. Results from ResNet-50 and the best in test example NN model were visualized using regression plots which plotted predicted lodging scores (y_predict) against actual scores (y_test). Models were also evaluated based on total model training time (in minutes, min) and inference time on the test dataset presented as mean±standard deviation per image in milliseconds (ms).

Accuracy: accuracy represents the proportion of correctly predicted data points over all data points. It is the most common way to evaluate a classification model and works well when the dataset is balanced.

$$Accuracy = \frac{tp + tn}{tp + fp + tn + fn} \times 100$$

where tp=true positives, fp=false positives, tn=true negatives and fn=false negatives.

Cohen's kappa coefficient: Cohen's kappa (κ) expresses the level of agreement between two annotators, which in this case is the classifier and the human operator on a classification problem. The kappa score ranges between −1 to 1, with scores above 0.8 generally considered good agreement.

$$κ = \frac{( {p}_{o} - {p}_{e} )}{( 1 - {p}_{e} )}$$

where pₒ is the empirical probability of agreement on the label assigned to any sample (the observed agreement ratio), and pₑ is the expected agreement when both annotators assign labels randomly.

Root mean-squared error (RMSE): root mean-squared error provides an idea of how much error a model typically makes in its prediction, with a higher weight for large errors. As such, RMSE is sensitive to outliers and other performance metrics may be more suitable when there are many outlier districts.

$$R MSE = \sqrt{{\sum }_{i = 1}^{n} \frac{{( {\hat{y}}_{i} - {y}_{i} )}^{2}}{n}}$$

where ŷᵢ . . . ŷₙ are predicted values, yᵢ . . . yₙ are observed values, and n is the number of observations.

Mean absolute error (MAE): mean absolute error, also called the average absolute deviation is another common metric used to measure prediction errors in a model by taking the sum of absolute value of error. Compared to RMSE, MAE gives equal weight to all errors and as such may be less sensitive to the effects of outliers.

$$M A E = \frac{1}{n} {\sum }_{i = 1}^{n} \vert {y}_{i} - {\hat{y}}_{i} \vert$$

where ŷᵢ . . . ŷₙ are predicted values, yᵢ . . . yₙ are observed values, and n is the number of observations.

Mean absolute percentage error (MAPE): mean absolute percentage error is the percentage equivalent of MAE, with the errors scaled against the observed values. MAPE may be less sensitive to the effects of outliers compared to RMSE but is biased towards predictions that are systematically less than the actual values due to the effects of scaling.

$$MAPE = \frac{1}{n} {\sum }_{i = 1}^{n} \vert \frac{{y}_{i} - {\hat{y}}_{i}}{{y}_{i}} \vert \times 100$$

where ŷᵢ . . . ŷₙ are predicted values, yᵢ . . . yₙ are observed values, and n is the number of observations.

Coefficient of determination (R²): coefficient of determination is a value between 0 and 1 that measures how well a regression line fits the data. It can be interpreted as the proportion of variance in the independent variable that can be explained by the model.

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - \overline{y} )}^{2}}$$

where ŷᵢ . . . ŷₙ are predicted values, yᵢ . . . yₙ are observed values, y̅ is the mean of observed values, and n is the number of observations.

Both transfer learning with pretrained CNNs (e.g., ResNet-50) and the example NN model performed strongly in the image classification task, as shown in Table 5. In one test, best in test example NN model (from 100 trials) achieved an accuracy of 92.0% (as shown in FIG. 13(b)), which was higher than the accuracy of 90.4% obtained by the ResNet-50 model (as shown in FIG. 13(a)), and a closer inspection at the confusion matrices of both models in that test showed that they had very similar classification performance, with the better performance of the example NN model explained by having a higher number of true negatives (100) and lower false positives (2) when compared to the ResNet-50 model (94 true negatives, 7 false positives). The example NN model was able to achieve these results using a simple 2-layers CNN (43,859 parameters) consisting only of a single 2D convolutional layer (as shown in FIG. 14) as opposed to the 50-layers deep ResNet-50 architecture (˜25 million parameters). In another test, transfer learning performance with the pretrained CNNs ranged from 91.6 to 93.2% classification accuracy, with Xception (accuracy=93.2%, kappa=08612) and DenseNet-201 (accuracy=93.2%, kappa=0.8599) giving the best tested overall accuracy (Table 5). Among the pretrained CNNs, InceptionV3 had the fastest training (5.42 min) and inference (0.4022±0.0603 ms per image) times, whereas DenseNet-201 had the slowest training (11.79 min) and inference (0.7524±0.0568 ms per image) times. In comparison, the performance of the example NN model ranged from 86.8 to 92.4% accuracy, with performance improving as more models (trials) were evaluated (Table 5). The best in test example NN model was discovered from 100 trials and had the same 92.4% accuracy as the ResNet-50 (Table 5). Inference time on the test dataset for the 2-layer CNN model (8.46 ms±46.6 μs) was ˜10-fold faster compared to the ResNet-50 model (87.3 ms±18.9 ms), ˜18-fold faster compared to the InceptionV3 and up to ˜33-fold faster compared to the DenseNet-201 (Table 5); however, model training times for the example NN model were significantly higher compared to the transfer learning approaches, with the longest training time of 251 min recorded for 100 trials, which was ˜21-fold higher compared to the DenseNet-201 (Table 5). Confusion matrices of the test set for the best tested models from transfer learning and AutoML for image classification are presented in Table 6. The example NN model's performance improved as more models (trials) were evaluated, as reflected in the increase in model classification accuracy from 10 to 100 trials (as shown in FIG. 15). Examination of the example NN model returned by AutoKeras revealed that the best tested model architecture resulting from the 10 and 25 trials was a deep CNN model comparable in depth and complexity to the ResNet-50, highlighting the ability of the example NN method and system to explore deep CNN architectures even in a small model search space. Subsequently, when the model search space was extended to 50 and 100 trials in one test, the best tested model architecture discovered by the example NN method and system (using AutoKeras) was the 2-layers CNN model (as shown in FIG. 15).

For the image regression task test, transfer learning with DenseNet-201 gave the best tested overall performance (R²=0.8303, RMSE=9.55, MAE=7.03, MAPE=12.54%), followed closely by the example NN model (from 100 trials) (R²=0.8273, RMSE=10.65, MAE=8.24, MAPE=13.87%) compared to transfer learning, e.g., using ResNet-50 (R²=0.8079, RMSE=10.81, MAE=7.84, MAPE=14.64%) (as shown in Table 3). The CNN models varied in regression performance, with R² ranging between 0.76-0.83. Within the pretrained CNNs, DenseNet-201 had the slowest model training (7.01 min) and per image inference (0.8141±0.1059 ms) times, with ResNet-50 having the fastest training (3.55 min) time, with a per image inference time of 0.5502±0.0716 ms. For the tested example NN method and system, performance generally improved from 10 to 100 trials (Table 7). The example NN method and system (using AutoKeras) was able to achieve this performance using an 8-layers CNN resembling a truncated mini Xception network with 207,560 total parameters (as shown in FIG. 16). Two prominent features of the original 71-layers deep Xception network, namely the use of depthwise separable convolution layers and skip connections were evident in the example NN model (as shown in FIG. 16). Inference time on the test dataset for the mini Xception model (57.5 ms±17.8 ms) was comparable to the ResNet-50 (55.1 ms±10.7 ms). Results from these experiments showed continued performance gains with more models being explored from 10 trials to 100 trials, as reflected in lower error scores and an increase in R² from 0.7568 to 0.8273 (as shown in Table 3). In another test, the mini Xception network outperformed the original pretrained Xception network (R2=0.7709, RMSE=11.08, MAE=8.22, MAPE=13.51%) (Table 7). Not surprisingly, the mini Xception network had the fastest per image inference time (0.0199±0.0008 ms) compared to the other models, which was ˜27-fold faster compared to the ResNet-50 and up to 41-fold faster compared to the DenseNet-201 (Table 7); however, model training times for example NN method and system was again significantly higher compared to the transfer learning approaches, with the longest training time of 325 min recorded for 100 trials, which was ˜46 fold higher compared to the DenseNet-201 (Table 7). Examination of the model architectures returned by example NN method and system (AutoKeras) revealed that the best tested model architecture resulting from the 10 and 25 trials was a deep CNN model (with more than 50 layers) whereas the best tested model architecture discovered from 50 and 100 trials was the 8-layers mini Xception model (as shown in FIG. 16).

TABLE 3
Performance metrics of modals in image regression (best tested
scores for each category are indicated with underlining):

| Model | R² | RMSE | MAE | MAPE |
|---|---|---|---|---|
| ResNet-50 | 0.8079 | 10.81 | 7.84 | 14.64% |
| NN model (10 trials) | 0.7568 | 12.43 | 9.54 | 14.55% |
| NN model (25 trials) | 0.7772 | 12.28 | 8.62 | 14.38% |
| NN model (50 trials) | 0.8133 | 10.71 | 8.31 | 13.92% |
| NN model (100 trials) | 0.8273 | 10.65 | 8.24 | 13.87% |

The best tested NN model had better performance scores across the board compared to the ResNet-50 model, with the exception that the ResNet-50 had a lower MAE of 7.84 compared to a score of 8.24 by the NN model (as shown in Table 3). A closer inspection of the regression plots for both models showed that the NN model had a much higher number of predictions exceeding the maximum value of 100 (n=39), with the largest predicted value being 118 whereas the ResNet-50 model only have one prediction exceeding 100 with a value of 100.29 (as shown in FIG. 17). This may explain why the MAE score, which is the average of the absolute difference between predicted scores and actual scores for the ResNet-50 model was lower compared to the NN model. The occurrence of predictions exceeding the maximum limit of 100 was possible in the experiment, so predicted values exceeding 100 were assigned or binned to a value of 100, which led to a noticeable improvement in performance scores for the NN model (R2=0.8351, RMSE=10.10, MAE=7.09, MAPE=12.70%) with no changes observed for the ResNet-50 model.

The exemplary use of lodging severity introduced a fractional binning (1/3, 2/3, 3/3) of lodging scores, leading to a slightly staggered distribution as evidenced in the regression plots (as shown in FIG. 10).

Table 4, showing Adam optimizer learning rates used in transfer learning, wherein the Adam optimizer was applied with the indicated learning rate and decay=learning rate/10:

| Network | Task | 1^{st} Training* | 2^{nd} Training* |
|---|---|---|---|
| VGG16 | classification | 1 × 10e−2 | 1 × 10e−4 |
| VGG19 | classification | 1 × 10e−1 | 1 × 10e−4 |
| ResNet-50 | classification | 1 × 10e−1 | 1 × 10e−4 |
| ResNet-101 | classification | 1 × 10e−2 | 1 × 10e−4 |
| InceptionV3 | classification | 1 × 10e−1 | 1 × 10e−4 |
| Xception | classification | 1 × 10e−1 | 1 × 10e−4 |
| DenseNet-169 | classification | 1 × 10e−2 | 1 × 10e−3 |
| DenseNet-201 | classification | 1 × 10e−2 | 1 × 10e−3 |
| VGG16 | regression | 1 × 10e−1 | 1 × 10e−4 |
| VGG19 | regression | 1 × 10e−2 | 1 × 10e−5 |
| ResNet-50 | regression | 1 × 10e−2 | 1 × 10e−3 |
| ResNet-101 | regression | 1 × 10e−1 | 1 × 10e−3 |
| InceptionV3 | regression | 1 × 10e−1 | 1 × 10e−3 |
| Xception | regression | 1 × 10e−2 | 1 × 10e−3 |
| DenseNet-169 | regression | 1 × 10e−1 | 1 × 10e−3 |
| DenseNet-201 | regression | 1 × 10e−2 | 1 × 10e−3 |

Table 5, showing model performance metrics for image classification:

| | | Training | Inference | Accuracy | |
|---|---|---|---|---|---|
| Network | Parameters | (min) | (ms) | (%) | Kappa |
| VGG16 | 14,715,201 | 6.03 | 0.5868 ± 0.0821 | 92.0 | 0.8355 |
| VGG19 | 20,024,897 | 7.01 | 0.6468 ± 0.1035 | 91.6 | 0.8269 |
| ResNet-50 | 23,589,761 | 5.89 | 0.4776 ± 0.0621 | 92.4 | 0.8449 |
| ResNet-101 | 42,660,225 | 9.88 | 0.7469 ± 0.1046 | 92.8 | 0.8524 |
| InceptionV3 | 21,804,833 | 5.42 | 0.4022 ± 0.0603 | 92.8 | 0.8521 |
| Xception | 20,863,529 | 9.06 | 0.5928 ± 0.0831 | 93.2 | 0.8612 |
| DenseNet-169 | 12,644,545 | 9.23 | 0.6113 ± 0.0917 | 92.8 | 0.8528 |
| DenseNet-201 | 18,323,905 | 11.79 | 0.7524 ± 0.0568 | 93.2 | 0.8599 |
| NN model | 23,566,856 | 16.06 | 0.4094 ± 0.0573 | 86.8 | 0.7484 |
| (10 trials) | | | | | |
| NN model | 23,566,856 | 29.18 | 0.4418 ± 0.0533 | 88.4 | 0.7595 |
| (25 trials) | | | | | |
| NN model | 43,859 | 102.43 | 0.0233 ± 0.0026 | 89.6 | 0.7901 |
| (50 trials) | | | | | |
| NN model | 43,859 | 251.80 | 0.0228 ± 0.0005 | 92.4 | 0.8457 |
| (100 trials) | | | | | |

Table 6, showing confusion matrices for the test set in Table 5 for the best tested models from transfer learning and the NN model:

| Model | Classes | Non-lodged | Lodged |
|---|---|---|---|
| Xception | Non-lodged | 98 | 3 |
| | Lodged | 14 | 135 |
| DenseNet-201 | Non-lodged | 95 | 6 |
| | Lodged | 11 | 138 |
| NN model (100 | Non-Lodged | 99 | 2 |
| trials) | Lodged | 17 | 132 |

Table 7, showing model performance metrics of modals for image regression:

| | | Training | Inference | | | | MAPE |
|---|---|---|---|---|---|---|---|
| Network | Parameters | (min) | (ms) | R² | RMSE | MAE | (%) |
| VGG16 | 14,715,201 | 3.71 | 0.6310 ± 0.0883 | 0.7590 | 11.37 | 8.97 | 14.02 |
| VGG19 | 20,024,897 | 4.32 | 0.7213 ± 0.1141 | 0.7707 | 11.03 | 9.19 | 16.01 |
| ResNet-50 | 23,589,761 | 3.55 | 0.5502 ± 0.0716 | 0.7844 | 10.79 | 8.28 | 15.51 |
| ResNet-101 | 42,660,225 | 5.85 | 0.7977 ± 0.1117 | 0.7730 | 11.10 | 8.38 | 15.67 |
| InceptionV3 | 21,804,833 | 3.32 | 0.4318 ± 0.0648 | 0.7642 | 11.09 | 8.07 | 13.90 |
| Xception | 20,863,529 | 5.33 | 0.6452 ± 0.0903 | 0.7709 | 11.08 | 8.22 | 13.51 |
| DenseNet-169 | 12,644,545 | 6.65 | 0.6545 ± 0.0982 | 0.7985 | 10.31 | 7.68 | 13.63 |
| DenseNet-201 | 18,323,905 | 7.01 | 0.8141 ± 0.1059 | 0.8303 | 9.55 | 7.03 | 12.54 |
| NN model (10 | 23,566,856 | 32.25 | 0.5574 ± 0.0009 | 0.7568 | 12.43 | 9.54 | 14.55 |
| trials) | | | | | | | |
| NN model (25 | 23,566,856 | 123.08 | 0.5719 ± 0.0008 | 0.7772 | 12.28 | 8.62 | 14.38 |
| trials) | | | | | | | |
| NN model (50 | 207,560 | 184.91 | 0.0198 ± 0.0008 | 0.8133 | 10.71 | 8.31 | 13.92 |
| trials) | | | | | | | |
| NN model (100 | 207,560 | 325.62 | 0.0199 ± 0.0008 | 0.8273 | 10.65 | 8.24 | 13.87 |
| trials) | | | | | | | |

### Interpretation

The reference herein to machine-readable storage media including machine readable instructions that, when executed by a computing system, perform a method, includes a computer memory encoding computer-executable instructions that, when executed by at least one processor, cause the at least one processor to perform a set of operations comprising said method.

Many modifications will be apparent to those skilled in the art without departing from the scope of the present invention.

The presence of “/” in a FIG. or text herein is understood to mean “and/or” unless otherwise indicated. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The terms “substantially” and “essentially all” can indicate a percentage greater than or equal to 90%, for instance, 92.5%, 95%, 97.5%, 99%, or 100%.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A method for image-based remote sensing of crop plants, the method including:
obtaining multispectral images of crop plants from a multispectral camera flown over the crop by an unmanned/uncrewed aerial vehicle (UAV);
mosaicking the multispectral images together using a structure-from-motion (SfM) method to produce:
a multispectral orthomosaic reflectance map of the crop plants,
a digital surface model (DSM) of the crop plants, and
a digital terrain model (DTM) of the crop plants;
determining a crop height model (CHM) representing the crop plants in three dimensions (3D) from a fusion of the DSM and the DTM;
determining an optimized soil adjusted vegetation index (OSAVI) based on the multispectral orthomosaic reflectance map; and
determining a measurement of biomass of the crop plants by comparing the CHM and the OSAVI, including:
determining crop volume (CV) through a fusion of CHM and crop coverage (CC) to measure entire volume of the standing crop to model dry weight (DW) biomass, and/or
modelling fresh weight (FW) biomass through a fusion of CV and vegetation indices (VIs).

2. The method of claim 1, wherein the SfM method includes using green bands of the multispectral images as a reference band.

3. The method of claim 1, wherein the SfM method includes geometrically registering the orthomosaic reflectance map with the DSM and the DTM using one or more ground control points (GCPs) in the images adjacent to or in the crop.

4. The method of claim 1, including determining the CC from a fusion of the OSAVI and the CHM.

5. The method of claim 1, wherein the CHM and the multispectral orthomosaic reflectance map are complementary and both represent the same crop area.

6. A system for image-based remote sensing of crop plants, the system including an aerial data acquisition system with:
an unmanned/uncrewed aerial vehicle (UAV); and
a multispectral camera mounted to the UAV for acquiring multispectral images of the crop plants,
the system further including a computing system configured to perform a data-processing method including:
mosaicking the multispectral images together using a structure-from-motion (SfM) method to produce:
a multispectral orthomosaic reflectance map of the crop plants,
a digital surface model (DSM) of the crop plants, and
a digital terrain model (DTM) of the crop plants;
determining a crop height model (CHM) representing the crop plants in three dimensions (3D) from a fusion of the DSM and the DTM;
determining an optimized soil adjusted vegetation index (OSAVI) based on the multispectral orthomosaic reflectance map; and
determining a measurement of biomass of the crop plants by comparing the CHM and the OSAVI, including:
determining crop volume (CV) through a fusion of CHM and crop coverage (CC) to measure entire volume of the standing crop to model dry weight (DW) biomass, and/or
modelling fresh weight (FW) biomass through a fusion of CV and vegetation indices (VIs).

7. Machine-readable storage media including machine readable instructions that, when executed by a computing system, perform a data-processing method including:
mosaicking multispectral images of crop plants together using a structure-from-motion (SfM) method to produce:
a multispectral orthomosaic reflectance map of the crop plants,
a digital surface model (DSM) of the crop plants, and
a digital terrain model (DTM) of the crop plants;
determining a crop height model (CHM) representing the crop plants in three dimensions (3D) from a fusion of the DSM and the DTM;
determining an optimized soil adjusted vegetation index (OSAVI) based on the multispectral orthomosaic reflectance map; and
determining a measurement of biomass of the crop plants by comparing the CHM and the OSAVI, including:
determining crop volume (CV) through a fusion of CHM and crop coverage (CC) to measure entire volume of the standing crop to model dry weight (DW) biomass, and/or
modelling fresh weight (FW) biomass through a fusion of CV and vegetation indices (VIs).

8. (canceled)

9. (canceled)

10. (canceled)

11. (canceled)

12. (canceled)

13. (canceled)

14. (canceled)

15. (canceled)

16. (canceled)

17. (canceled)

18. The method of claim 4, wherein the fusion of the OSAVI and the CHM includes a pixel-wise product of the OSAVI and the CHM.

19. The method of claim 4, wherein any one or more of the following applies:
i) the CC is in the form of a CC layer;
ii) the OSAVI is in the form of an OSAVI layer; and
iii) the CHM is in the form of a CHM layer.

20. The method of claim 4, wherein the OSAVI is in the form of an OSAVI layer, the CHM is in the form of a CHM layer, and the CC is in the form of a CC layer, wherein the fusion of the OSAVI and the CHM includes a pixel-wise product of the OSAVI layer and the CHM layer.
